(19) United States
(12) Patent Application Publication
(10) Pub. No.: US 2024/0270947 A1
(43) Pub. Date: Aug. 15, 2024

(54) RESIN COMPOSITION, RESIN COMPOSITION MOLDED BODY, POWER CABLE, AND METHOD OF PRODUCING POWER CABLE

(71) Applicant: SUMITOMO ELECTRIC INDUSTRIES, LTD., Osaka (JP)

(72) Inventors: Satoshi YAMASAKI, Osaka (JP); Fumitoshi IYODA, Osaka (JP); Takanori YAMAZAKI, Osaka (JP)

(73) Assignee: SUMITOMO ELECTRIC INDUSTRIES, LTD., Osaka (JP)

(21) Appl. No.: 18/266,836

(22) PCT Filed: Oct. 14, 2021
(86) PCT No.: PCT/JP2021/037994

§ 371 Date: Jun. 13, 2023

(30) Foreign Application Priority Data
Dec. 21, 2020 (JP) 2020-211489

(51) Int. Cl. C08L 23/10; H01B 3/44; H01B 9/00; H01B 13/14

(52) U.S. Cl. CPC C08L 23/10; H01B 3/44; H01B 13/14; C08L 2203/20; H01B 9/00

(57) ABSTRACT

A resin composition to be coated on a circumference of an elongated object, including propylene units, wherein there are no voids with a maximum length of 1 μm or more nor crystals with a maximum length of more than 10 μm in a molded body including the resin composition after a predetermined bending test, where the bending test includes a first step of bending the power cable so that a bending ratio of a bending radius of the power cable to an outer diameter of the insulating layer is 7 or less, and a second step of bending the power cable in a direction opposite to a bending direction in the first step at the same bending ratio as the bending ratio in the first step.

### TECHNICAL FIELD

The present disclosure relates to a resin composition, a resin composition molded body, a power cable, and a method of producing the power cable.

The present application claims priority based on Japanese Laid-Open Patent Publication No. 2020-211489 filed on Dec. 21, 2020, the content of which is incorporated herein by reference in its entirety.

### BACKGROUND ART

Crosslinked polyethylene is excellent in an insulation, and therefore has been widely used as a resin component constituting an insulating layer in a power cable and the like (e.g., PTL. 1).

### CITATION LIST

### Patent Literature

PTL. 1: Japanese Laid-Open Patent Publication No. S57-69611

### SUMMARY OF INVENTION

### Solution to Problem

According to an aspect of the present disclosure,
there is provided a resin composition to be coated on a circumference of an elongated object, including propylene units,
wherein there are no voids with a maximum length of 1 μm or more nor crystals with a maximum length of more than 10 μm in a molded body including the resin composition after a predetermined bending test,
where the bending test includes a first step of bending the molded body so that a bending ratio of a bending radius of the molded body to an outer diameter of the molded body is 7 or less, and a second step of bending the molded body in a direction opposite to a bending direction in the first step at the same bending ratio as the bending ratio in the first step.

According to another aspect of the present disclosure,
there is provided a resin composition molded body coated on a circumference of an elongated object, including propylene units,
wherein there are no voids with a maximum length of 1 μm or more nor crystals with a maximum length of more than 10 μm in the resin composition molded body after a predetermined bending test,
where the bending test includes a first step of bending the resin composition molded body so that a bending ratio of a bending radius of the resin composition molded body to an outer diameter of the resin composition molded body is 7 or less, and a second step of bending the resin composition molded body in a direction opposite to a bending direction in the first step at the same bending ratio as the bending ratio in the first step.

According to yet another aspect of the present disclosure,
there is provided a resin composition molded body, including propylene units,
wherein the resin composition molded body satisfies a first requirement, a second requirement, and a third requirement in a distribution of number of counts with respect to an elastic modulus of the resin composition molded body, determined by a micro-region elasticity measurement using a scanning probe microscope,
where the elastic modulus is measured under conditions of tapping within a 10 μm square area of the resin composition molded body 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

According to yet another aspect of the present disclosure,
there is provided a resin composition molded body, including:
   a resin A that contains propylene units, and
   a resin B that contains 2 or more types of monomer units and is solid at 25° C.,
wherein a storage modulus of the resin A at 25° C. measured by a dynamic mechanical analysis is 600 MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

According to yet another aspect of the present disclosure,
there is provided a resin composition molded body, including:
   a resin A that contains propylene units, and
   a resin B that contains 2 or more types of monomer units and is solid at 25° C.,
wherein a ratio of a storage modulus of the resin A to a storage modulus of the resin B, at 25° C. measured by a dynamic mechanical analysis, is 5 or more and 200 or less, and
a content of the resin A is 52 parts by mass or more and 95 parts by mass or less with respect to a total content of the resin A and the resin B being 100 parts by mass.

According to yet another aspect of the present disclosure,
there is provided a resin composition molded body, including:
   a resin A that contains propylene units, and
   a resin B that contains 2 or more types of monomer units,
wherein a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less,
a content of the resin A is 52 parts by mass or more and 95 parts by mass or less with respect to a total content of the resin A and the resin B being 100 parts by mass,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

According to yet another aspect of the present disclosure,
there is provided a power cable including:
   a conductor, and
   an insulating layer coated on a circumference of the conductor,
wherein the insulating layer includes propylene units, and
there are no voids with a maximum length of 1 μm or more nor crystals with a maximum length of more than 10 μm in the insulating layer after a predetermined bending test.

According to yet another aspect of the present disclosure,
there is provided a power cable including:
   a conductor, and
   an insulating layer coated on a circumference of the conductor,
wherein the insulating layer includes propylene units, and
the insulating layer satisfies a first requirement, a second requirement, and a third requirement in a distribution of number of counts with respect to an elastic modulus of the insulating layer, determined by a micro-region elasticity measurement using a scanning probe microscope.

According to yet another aspect of the present disclosure,
there is provided a power cable including:
   a conductor, and
   an insulating layer coated on a circumference of the conductor,
wherein the insulating layer includes
   a resin A that contains propylene units, and
   a resin B that contains 2 or more types of monomer units and is solid at 25° C.,
a storage modulus of the resin A at 25° C. measured by a dynamic mechanical analysis is 600 MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

According to yet another aspect of the present disclosure,
there is provided a power cable including:
   a conductor, and
   an insulating layer coated on a circumference of the conductor,
wherein the insulating layer includes
   a resin A that contains propylene units, and
   a resin B that contains 2 or more types of monomer units and is solid at 25° C.,
a ratio of a storage modulus of the resin A to a storage modulus of the resin B, at 25° C. measured by a dynamic mechanical analysis, is 5 or more and 200 or less,
a content of the resin A is 52 parts by mass or more and 95 parts by mass or less with respect to a total content of the resin A and the resin B being 100 parts by mass.

According to yet another aspect of the present disclosure,
there is provided a power cable including:
   a conductor, and
   an insulating layer coated on a circumference of the conductor,
wherein the insulating layer includes
   a resin A that contains propylene units, and
   a resin B that contains 2 or more types of monomer units,
a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less, and
a content of the resin A is 52 parts by mass or more and 95 parts by mass or less with respect to a total content of the resin A and the resin B being 100 parts by mass.

According to yet another aspect of the present disclosure,
there is provided a method of producing a power cable, including:
   preparing a resin composition including a resin A that contains propylene units and a resin B that contains 2 or more types of monomer units and is solid at 25° C.; and
   coating an insulating layer on a circumference of a conductor using the resin composition,
wherein, in the preparation of the resin composition,
a storage modulus of the resin A at 25° C. measured by a dynamic mechanical analysis is set to 600 MPa or more and 1200 MPa or less,
a storage modulus of the resin B at 25° C. measured by a dynamic mechanical analysis is set to 1 MPa or more and 200 MPa or less, and
a content of the resin A is set to 52 parts by mass or more and 95 parts by mass or less with respect to a total content of the resin A and the resin B being 100 parts by mass.

According to yet another aspect of the present disclosure,
there is provided a method of producing a power cable, including:
   preparing a resin composition including a resin A that contains propylene units and a resin B that contains 2 or more types of monomer units and is solid at 25° C.; and
   coating an insulating layer on a circumference of a conductor using the resin composition,
wherein, in the preparation of the resin composition,
a ratio of a storage modulus of the resin A to a storage modulus of the resin B, at 25° C. measured by a dynamic mechanical analysis, is set to 5 or more and 200 or less, and
a content of the resin A is set to 52 parts by mass or more and 95 parts by mass or less with respect to a total content of the resin A and the resin B being 100 parts by mass.

According to yet another aspect of the present disclosure,
there is provided a method of producing a power cable, including:
   preparing a resin composition including a resin A that contains propylene units and a resin B that contains 2 or more types of monomer units, and
   coating an insulating layer on a circumference of a conductor using the resin composition,
wherein, in the preparation of the resin composition,
a peak molecular weight in a molecular weight distribution of the resin A is set to 6×10⁴ or more and 6×10⁵ or less,
Mw/Mn of the resin A is set to 3.0 or more and 8.0 or less,
a peak molecular weight in a molecular weight distribution of the resin B is set to 4×10⁴ or more and 4×10⁵ or less,
Mw/Mn of the resin B is set to 1.1 or more and 3.0 or less, and
a content of the resin A is set to 52 parts by mass or more and 95 parts by mass or less with respect to a total content of the resin A and the resin B being 100 parts by mass.

### BRIEF DESCRIPTION OF DRAWINGS

FIG. 1 is a diagram illustrating examples of respective molecular weight distributions of the resin A and the resin B according to an embodiment of the present disclosure.

FIG. 2 is a schematic cross-sectional diagram orthogonal to an axial direction of a power cable according to an embodiment of the present disclosure.

FIG. 3 is a diagram illustrating an example of the results of micro-region elasticity measurement.

### DESCRIPTION OF EMBODIMENTS

### Problem to be Solved by Disclosure

Crosslinked polyethylene has been widely used for an insulating layer in a power cable, but crosslinked polyethylene that has been degraded over time cannot be recycled and has no choice but to be incinerated. For this reason, there is concern about the influence on environment.

In recent years, as resin components included in the insulating layer, propylene-containing resins (hereinafter also referred to as “propylene-based resins”) have attracted attention as the resin components constituting the insulating layer. The propylene-based resins, even non-crosslinked ones, can achieve an insulation required for a power cable. In other words, both the insulation and recyclability can be achieved.

An object of the present disclosure is to provide a technique that can improve an insulation of a molded body containing a propylene-based resin.

### Advantageous Effect of Disclosure

According to the present disclosure, the insulation of the molded body containing the propylene-based resin can be improved.

### Description of Embodiments of Disclosure

### Knowledges Obtained by the Inventors

First, an outline of the knowledges obtained by the inventors will be described.

In general, polypropylene itself is harder than polyethylene and the like.

For this reason, conventionally, a resin component obtained by adding ethylene-propylene rubber (EPR) or the like to polypropylene has been used in the technical field of bumpers for automobiles and the like. The resin component can be made more flexible by adding EPR or the like to polypropylene.

In view of this, in order to improve the flexibility of an insulating layer in the technical field of power cables, the present inventors tried adding a flexible resin such as EPR as a resin component constituting the insulating layer to a propylene-based resin.

However, as a result of conducting studies about adding a flexible resin to a propylene-based resin in an insulating layer, the present inventors found that an insulation of the insulating layer may be degraded after a power cable is bent.

As a result of analyzing the insulating layer whose insulation is degraded due to the bending, it is found that such a degradation of the insulation after the bending is resulting from a mechanism described below.

An elastic modulus of the flexible resin is lower than an elastic modulus of the polypropylene-based resin, as described above. Each resin has an inherent molecular weight distribution that correlates its elastic modulus. As a result, a molecular weight distribution of the flexible resin and a molecular weight distribution of the polypropylene-based resin are different from each other.

When two resins with different molecular weight distributions as described above are mixed, at least one of the resins may be localized in some cases.

For example, components that have a high elastic modulus derived from the polypropylene-based resin may be locally concentrated. A region in which the components having a high elastic modulus are locally concentrated is hereinafter referred to as a “high-elastic region”. A high-elastic region derived from the polypropylene-based resin has a high crystallinity. Therefore, the high-elastic region is hard.

On the other hand, for example, components that have a low elastic modulus derived from the flexible resin may be locally concentrated. A region in which the components having a low elastic modulus are locally concentrated is hereinafter referred to as a “low-elastic region”. A low-elastic region derived from the flexible resin has a low crystallinity (to become amorphous). Therefore, the low-elastic region is flexible.

Even when the resins are localized in the insulating layer as described above, there is no problem in the insulation immediately after production. However, when the resins are localized in the insulating layer, bending the power cable may cause the following phenomena.

When the power cable is bent, a local stress will be applied in the resin components. When the local stress is applied, for example, the crystals crack or separate from each other in the high-elastic region, which may generate fine voids. Alternatively, a crystalline high-elastic region and an amorphous low-elastic region separate from each other at their interface, which may generate fine voids. Alternatively, even in the amorphous low-elastic region, separation or flaking may be generated along the interface of materials, particularly materials having poor compatibility with each other, which may generate fine voids. Note that the “voids” used herein include crackings.

Moreover, when the local stress is applied in the resin components, a mechanical strain may trigger generation of coarse crystals (spherulites), for example, inside the high-elastic region derived from the polypropylene-based resin.

The insulation is degraded in the fine voids and coarse crystals generated during the bending as described above. Therefore, when a high electric field is applied to the power cable, the electric field may concentrate on the fine voids and the coarse crystals in the insulating layer, resulting in dielectric breakdown of the insulating layer.

Thus, as a result of intensive studies, the present inventors have found that the degradation of the insulation after the bending can be reduced by suppressing generation of fine voids and coarse crystals during the bending.

The present disclosure is based on the above-described knowledges found by the inventors.

### Embodiments of Disclosure

Next, embodiments of the present disclosure will be listed and described.
[1] A resin composition according to an aspect of the present disclosure is
a resin composition to be coated on a circumference of an elongated object, including propylene units,
wherein there are no voids with a maximum length of 1 μm or more nor crystals with a maximum length of more than 10 μm in a molded body including the resin composition after a predetermined bending test,
where the bending test includes a first step of bending the molded body so that a bending ratio of a bending radius of the molded body to an outer diameter of the molded body is 7 or less, and a second step of bending the molded body in a direction opposite to a bending direction in the first step at the same bending ratio as the bending ratio in the first step.

According to this configuration, degradation of the insulation after the bending can be reduced.
[2] A resin composition molded body according to an aspect of the present disclosure is
a resin composition molded body coated on a circumference of an elongated object, including propylene units,
wherein there are no voids with a maximum length of 1 μm or more nor crystals with a maximum length of more than 10 μm in the molded body after a predetermined bending test,
where the bending test includes a first step of bending the resin composition molded body so that a bending ratio of a bending radius of the resin composition molded body to an outer diameter of the resin composition molded body is 7 or less, and a second step of bending the resin composition molded body in a direction opposite to a bending direction in the first step at the same bending ratio as the bending ratio in the first step.

According to this configuration, degradation of the insulation after the bending can be reduced.
[3] In the resin composition molded body according to [2],
the resin composition molded body satisfies a first requirement, a second requirement, and a third requirement in a distribution of number of counts with respect to an elastic modulus of the resin composition molded body, determined by a micro-region elasticity measurement using a scanning probe microscope,
where the elastic modulus is measured under conditions of tapping within a 10 μm square area of the resin composition molded body 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

According to this configuration, generation of fine voids and coarse crystals during the bending can be suppressed.
[4] A resin composition according to yet another aspect of the present disclosure is
a resin composition molded body including propylene units,
wherein the resin composition molded body satisfies a first requirement, a second requirement, and a third requirement in a distribution of number of counts with respect to an elastic modulus of the resin composition molded body, determined by a micro-region elasticity measurement using a scanning probe microscope,
where the elastic modulus is measured under conditions of tapping within a 10 μm square area of the resin composition molded body 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

According to this configuration, degradation of the insulation after the bending can be reduced.
[5] In the resin composition molded body according to any one of [2] to [4],
the resin composition molded body includes
   a resin A that contains propylene units, and
   a resin B that contains 2 or more types of monomer units and is solid at 25° C.

According to this configuration, the molded body can be made flexible.
[6] In the resin composition molded body according to [5],
a content of the resin A is 52 parts by mass or more and 95 parts by mass or less with respect to a total content of the resin A and the resin B being 100 parts by mass.

According to this configuration, generation of fine voids and coarse crystals during the bending can be suppressed.
[7] In the resin composition molded body according to [5] or [6],
a storage modulus of the resin A at 25° C. measured by a dynamic mechanical analysis is 600 MPa or more and 1200 MPa or less, and
a storage modulus of the resin B at 25° C. measured by a dynamic mechanical analysis is 1 MPa or more and 200 MPa or less.

According to this configuration, the resin A and the resin B can be homogeneously mixed.
[8] A resin composition molded body according to another aspect of the present disclosure is
a resin composition molded body, including:
   a resin A that contains propylene units, and
   a resin B that contains 2 or more types of monomer units and is solid at 25° C.,
wherein a storage modulus of the resin A at 25° C. measured by a dynamic mechanical analysis is 600 MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

According to this configuration, degradation of the insulation after the bending can be reduced.
[9] In the resin composition molded body according to any one of [5] to [8],
the resin composition molded body includes
   a resin A that contains propylene units, and
   a resin B that contains 2 or more types of monomer units and is solid at 25° C.,
a ratio of a storage modulus of the resin A to a storage modulus of the resin B, at 25° C. measured by a dynamic mechanical analysis, is 5 or more and 200 or less.

According to this configuration, the resin A and the resin B can be homogeneously mixed.
[10] A resin composition molded body according to another aspect of the present disclosure includes:
   a resin A that contains propylene units, and
   a resin B that contains 2 or more types of monomer units and is solid at 25° C.,
wherein a ratio of a storage modulus of the resin A to a storage modulus of the resin B, at 25° C. measured by a dynamic mechanical analysis, is 5 or more and 200 or less, and
a content of the resin A is 52 parts by mass or more and 95 parts by mass or less with respect to a total content of the resin A and the resin B being 100 parts by mass.

According to this configuration, degradation of the insulation after the bending can be reduced.
[11] In the resin composition molded body according to any one of [5] to [10],
a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

According to this configuration, the resin A and the resin B can be homogeneously mixed.
[12] A resin composition molded body according to another aspect of the present disclosure includes:
   a resin A that contains propylene units, and
   a resin B that contains 2 or more types of monomer units,
wherein a peak molecular weight in a molecular weight distribution of the resin A is 6×10⁴ or more and 6×10⁵ or less,
Mw/Mn of the resin A is 3.0 or more and 8.0 or less, and
a peak molecular weight in a molecular weight distribution of the resin B is 4×10⁴ or more and 4×10⁵ or less,
Mw/Mn of the resin B is 1.1 or more and 3.0 or less, and
a content of the resin A is 52 parts by mass or more and 95 parts by mass or less with respect to a total content of the resin A and the resin B being 100 parts by mass,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

According to this configuration, degradation of the insulation after the bending can be reduced.
[13] A power cable according to another aspect of the present disclosure includes:
   a conductor, and
   an insulating layer coated on a circumference of the conductor,
wherein the insulating layer includes propylene units, and
there are no voids with a maximum length of 1 μm or more nor crystals with a maximum length of more than 10 μm in the insulating layer after a predetermined bending test,
where the bending test includes a first step of bending the power cable so that a bending ratio of a bending radius of the power cable to an outer diameter of the insulating layer is 7 or less, and a second step of bending the power cable in a direction opposite to a bending direction in the first step at the same bending ratio as the bending ratio in the first step.

According to this configuration, degradation of the insulation after the bending can be reduced.
[14] A power cable according to another aspect of the present disclosure includes:
   a conductor, and
   an insulating layer coated on a circumference of the conductor,
wherein the insulating layer includes propylene units, and
the insulating layer satisfies a first requirement, a second requirement, and a third requirement in a distribution of number of counts with respect to an elastic modulus of the insulating layer, determined by a micro-region elasticity measurement using a scanning probe microscope,
where the elastic modulus is measured under conditions of tapping within a 10 μm square area of the insulating layer 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

According to this configuration, degradation of the insulation after the bending can be reduced.
[15] A power cable according to another aspect of the present disclosure includes:
   a conductor, and
   an insulating layer coated on a circumference of the conductor,
wherein the insulating layer includes
   a resin A that contains propylene units, and
   a resin B that contains 2 or more types of monomer units and is solid at 25° C.,
a storage modulus of the resin A at 25° C. measured by a dynamic mechanical analysis is 600 MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

According to this configuration, degradation of the insulation after the bending can be reduced.
[16] A power cable according to another aspect of the present disclosure includes:
   a conductor, and
   an insulating layer coated on a circumference of the conductor,
wherein the insulating layer includes
   a resin A that contains propylene units, and
   a resin B that contains 2 or more types of monomer units and is solid at 25° C.,
a ratio of a storage modulus of the resin A to a storage modulus of the resin B, at 25° C. measured by a dynamic mechanical analysis, is 5 or more and 200 or less,
a content of the resin A is 52 parts by mass or more and 95 parts by mass or less with respect to the total content of the resin A and the resin B being 100 parts by mass.

According to this configuration, degradation of the insulation after the bending can be reduced.
[17] A power cable according to another aspect of the present disclosure includes:
   a conductor, and
   an insulating layer coated on a circumference of the conductor,
wherein the insulating layer includes
   a resin A that contains propylene units, and
   a resin B that contains 2 or more types of monomer units,
a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less, and
a content of the resin A is 52 parts by mass or more and 95 parts by mass or less with respect to a total content of the resin A and the resin B being 100 parts by mass,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

According to this configuration, degradation of the insulation after the bending can be reduced.
[18] A method of producing a power cable according to another aspect of the present disclosure includes:
   preparing a resin composition including a resin A that contains propylene units and a resin B that contains 2 or more types of monomer units and is solid at 25° C.; and
   coating an insulating layer on a circumference of a conductor using the resin composition,
wherein, in the preparation of the resin composition,
a storage modulus of the resin A at 25° C. measured by a dynamic mechanical analysis is set to 600 MPa or more and 1200 MPa or less,
a storage modulus of the resin B at 25° C. measured by a dynamic mechanical analysis is set to 1 MPa or more and 200 MPa or less, and
a content of the resin A is set to 52 parts by mass or more and 95 parts by mass or less with respect to a total content of the resin A and the resin B being 100 parts by mass.

According to this configuration, degradation of the insulation after the bending can be reduced.
[19] A method of producing a power cable according to another aspect of the present disclosure includes:
   preparing a resin composition including a resin A that contains propylene units and a resin B that contains 2 or more types of monomer units and is solid at 25° C.,
   coating an insulating layer on a circumference of a conductor using the resin composition,
wherein, in the preparation of the resin composition,
a ratio of a storage modulus of the resin A to a storage modulus of the resin B, at 25° C. measured by a dynamic mechanical analysis, is set to 5 or more and 200 or less, and
a content of the resin A is set to 52 parts by mass or more and 95 parts by mass or less with respect to a total content of the resin A and the resin B being 100 parts by mass.

According to this configuration, degradation of the insulation after the bending can be reduced.
[20] A method of producing a power cable according to another aspect of the present disclosure includes:
   preparing a resin composition including a resin A that contains propylene units and a resin B that contains 2 or more types of monomer units, and
   coating an insulating layer on a circumference of a conductor using the resin composition,
wherein, in the preparation of the resin composition,
a peak molecular weight in a molecular weight distribution of the resin A is set to 6×10⁴ or more and 6×10⁵ or less,
Mw/Mn of the resin A is set to 3.0 or more and 8.0 or less,
a peak molecular weight in a molecular weight distribution of the resin B is set to 4×10⁴ or more and 4×10⁵ or less,
Mw/Mn of the resin B is set to 1.1 or more and 3.0 or less, and
a content of the resin A is set to 52 parts by mass or more and 95 parts by mass or less with respect to a total content of the resin A and the resin B being 100 parts by mass,
where the molecular weight distribution of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

According to this configuration, degradation of the insulation after the bending can be reduced.

### Details of Embodiment of Disclosure

Next, an embodiment of the present disclosure will be described below with reference to the drawings. The present disclosure is not limited to these illustrations, but intended to be indicated by claims and encompass all the changes which fall within the meaning and scope equivalent to claims.

### One Embodiment of Disclosure

### (1) Resin Composition Molded Body

A resin composition molded body (also simply referred to as “molded body” hereinafter) according to this embodiment includes, for example, a resin composition, and is coated on a circumference of an elongated object. Specifically, the resin composition molded body constitutes an insulating layer 130 of a power cable 10, which will be described later, for example. An object for the resin composition molded body is an elongated linear conductor 110, for example. The resin composition molded body is formed through extrusion molding so as to cover the outer circumference of the conductor 110, for example. That is, the resin composition molded body has the same shape in the longitudinal direction of the object, for example. Also, the length of the resin composition molded body in the longitudinal direction of the object is, for example, 30 cm or more, and is preferably 50 cm or more. A thickness of the resin composition molded body coated on the object is, for example, 3 mm or more.

The resin composition molded body of this embodiment contains at least propylene units as resin components, for example. A “resin component” here refers to a resin material (polymer) constituting a main component of the resin composition molded body. A “main component” refers to a component in the highest content.

More specifically, the resin components constituting the resin composition molded body include the resin A which is a propylene-based resin and the resin B which is a flexible resin, for example. Mixing them can inhibit excessive crystal growth of the propylene-based resin and improve the flexibility of the insulating layer.

Also, the resin composition molded body of this embodiment is non-crosslinked, for example. Alternatively, even when the resin composition molded body of this embodiment is crosslinked, the gel fraction (the degree of crosslinking) of the resin composition molded body is low. Specifically, the residue of a crosslinking agent in the resin composition molded body is less than 300 ppm, for example. Note that when dicumyl peroxide is used as a crosslinking agent, examples of the residue include cumyl alcohol and a-methylstyrene. The recyclability of the resin composition molded body can be improved by using a non-crosslinked molded body or reducing the degree of crosslinking as described above.

### (Resin A: Propylene-Based Resin)

The resin A of this embodiment contains at least propylene units as main components, as described above. Examples of the resin A include propylene homopolymers (homo polypropylene), and propylene random polymers (random polypropylene).

When the resin composition of this embodiment is analyzed using a Nuclear Magnetic Resonance (NMR) system, at least propylene units are detected as monomer units derived from the resin A. For example, when the resin A is a propylene random polymer, propylene units and ethylene units are detected, and when the resin A is a propylene homopolymer, propylene units are detected.

In this embodiment, the tacticity of the propylene-based resin as the resin A is preferably isotactic, for example. The propylene-based resin is polymerized with a Ziegler-Natta catalyst and is versatile. Since the tacticity is isotactic, reduction in the melting point of the composition can be suppressed in the composition obtained by mixing the resin A and the resin B which is low-crystalline. As a result, it is possible to stably realize use thereof under non-crosslinking or slight crosslinking.

For reference, examples of other kinds of tacticity include syndiotactic and atactic, both of which are not preferable for the tacticity of the propylene-based resin of this embodiment. The PP-based resin having such tacticity cannot obtain a predetermined crystal structure, and itself has a lower melting point. In the composition obtained by mixing the PP-based resin and the resin B, the crystals of the PP-based resin are easily eroded by the resin B. Therefore, the melting point of the composition is lower than the melting point of the PP-based resin itself. As a result, it becomes difficult to use under non-crosslinking or slight crosslinking. For these reasons, syndiotactic and atactic are not preferred.

When the resin A is a propylene random polymer, the resin A includes the propylene units and the ethylene units, as described above. An ethylene content (ethylene unit content) in the propylene random polymer is 0.5 mass % or more and 15 mass % or less, for example. The growth of spherulites can be suppressed by setting the ethylene content to 0.5 mass % or more. On the other hand, by setting the ethylene content to 15 mass % or less, it is possible to suppress reduction in melting points and to stably realize use thereof under non-crosslinking or slight crosslinking.

The storage modulus, molecular weight, and content of the resin A, together with those of the resin B, will be described later in detail.

### (Resin B: Flexible Resin)

The resin B of this embodiment is a resin material, for example, having an elastic modulus lower than that of the resin A, and imparting flexibility to the resin composition molded body. The resin B may be considered as a low-crystallinity resin (amorphous resin), from a viewpoint of suppressing an excessive crystal growth of the resin A.

The resin B of this embodiment includes, for example, 2 or more types of monomer units. Specifically, the resin B includes a copolymer obtained by copolymerization of at least any two of ethylene, propylene, butene (butylene), hexene, octene, isoprene, and styrene. When the resin composition of this embodiment is analyzed using a NMR system, monomer units derived from the resin B are detected.

A carbon-carbon double bond in an olefinic monomer unit is preferably at an a-position, for example.

The resin B is preferably solid at 25° C., for example. The resin B being liquid at 25° C. corresponds to the one having an excessively low molecular weight as described below. In this case, it becomes difficult to homogeneously mix the resin A and the resin B. In contrast, the resin B which is solid at 25° C. can suppress excessive reduction in the molecular weight. This allows the resin A and the resin B to be homogeneously mixed.

Examples of the resin B that satisfies the above-described requirements include Ethylene-Propylene Rubber (EPR), Very Low Density Polyethylene (VLDPE), and styrene-based resin (styrene-containing resin). Two or more of them may be used in combination. Note that the density of VLDPE is, for example, 0.855 g/cm³ or more and 0.890 g/cm³ or less.

The resin B is preferably a copolymer containing propylene units, for example, from a viewpoint of compatibility with the resin A which is a propylene-based resin. As an exemplary copolymer containing propylene units, EPR is mentioned among those described above.

An ethylene content (ethylene unit content) in EPR is, for example, 20 mass % or more, preferably 40 mass % or more, and more preferably 55 mass % or more. When the ethylene content is less than 20 mass %, the compatibility of EPR with the propylene-based resin becomes excessively high. Thus, even when the EPR content in the molded body is reduced, the molded body can be made more flexible. However, the effect of inhibiting crystallization of the propylene-based resin (also referred to as “crystallization inhibitory effect”) may not be exhibited, and insulating properties may deteriorate due to microcracks in spherulites. In contrast, in this embodiment, by setting the ethylene content to 20 mass % or more, it is possible to suppress excessive increase in compatibility of EPR with the propylene-based resin. Therefore, it is possible to exhibit the crystallization inhibitory effect of EPR while obtaining the softening effect of EPR. As a result, the degradation of the insulation can be reduced. Furthermore, by setting the ethylene content to preferably 40 mass % or more and more preferably 55 mass % or more, it is possible to stably exhibit the crystallization inhibitory effect and stably reduce degradation in insulation.

On the other hand, the resin B may be, for example, a copolymer containing no propylene unit. From the viewpoint of high availability, VLDPE is preferable as the copolymer containing no propylene unit, for example. Examples of VLDPE include PE constituted by ethylene and 1-butene, and PE constituted by ethylene and 1-octene. By adding the copolymer containing no propylene unit as the resin B as described above, complete compatibility can be suppressed while a predetermined amount of the resin B is mixed in the propylene-based resin. The crystallization inhibitory effect can be exhibited by setting a content of the copolymer containing no propylene unit to a predetermined amount or more.

Alternatively, the resin B may be, for example, the styrene-based resin, as described above. The styrene-based resin is a copolymer containing styrene unit as a hard segment, and at least one type of monomer unit of ethylene, propylene, butylene, isoprene, and the like as a soft segment. The styrene-based resin can also be referred to as a styrene-based thermoplastic elastomer. Since the styrene-based resin contains relatively flexible monomer units and relatively rigid monomer units, moldability can be improved. Since the styrene-based resin also contains monomer units (e.g., butylene) highly compatible with the resin A that is a PP-based resin, the resin A and the resin B can be homogeneously mixed.

Examples of the styrene-based resin include styrene-butadiene-styrene block copolymers (SBS), hydrogenated styrene-butadiene-styrene block copolymers, styrene-isoprene-styrene copolymers (SIS), hydrogenated styrene-isoprene-styrene copolymers, hydrogenated-styrene-butadiene rubbers, hydrogenated styrene-isoprene rubbers, and styrene-ethylene-butylene-olefin crystalline block copolymers. Two or more of them may be used in combination.

The term “hydrogenated” as used herein means hydrogen being added to a double bond. For example, “hydrogenated styrene-butadiene-styrene block copolymer” means a polymer obtained by adding hydrogen to double bonds of the styrene-butadiene-styrene block copolymer. Note that double bonds in the aromatic ring included in styrene has no hydrogen added thereto. The term “hydrogenated styrene-butadiene-styrene block copolymer” can be also referred to as styrene-ethylene butylene-styrene block copolymer (SEBS).

Among the styrene-based resins, hydrogenated materials having no double bonds in their chemical structures excluding aromatic rings are preferred. When non-hydrogenated materials are used, the resin component may be thermally deteriorated, for example, at the time of molding of the resin composition, which may degrade the properties of the resulting molded body. In contrast, the use of the hydrogenated material can improve resistance to the thermal deterioration. As a result, the properties of the molded body can be maintained at a higher level.

A content of the styrene (also simply referred to as “styrene content” hereinafter) in the styrene-based resin is not particularly limited, but is preferably 5 mass % or more and 35 mass % or less, for example. By setting the styrene content within the above-described range, excessive hardening of the material can be suppressed. As a result, separation and cracking between the PP-based resin and the styrene-containing resin can be suppressed.

### (Molecular Weight Distribution)

As a result of intensive studies, the present inventors have found that by adjusting the molecular weight distribution of each of the resin A and the resin B itself, the above-described localization of each of the resin A and the resin B can be suppressed.

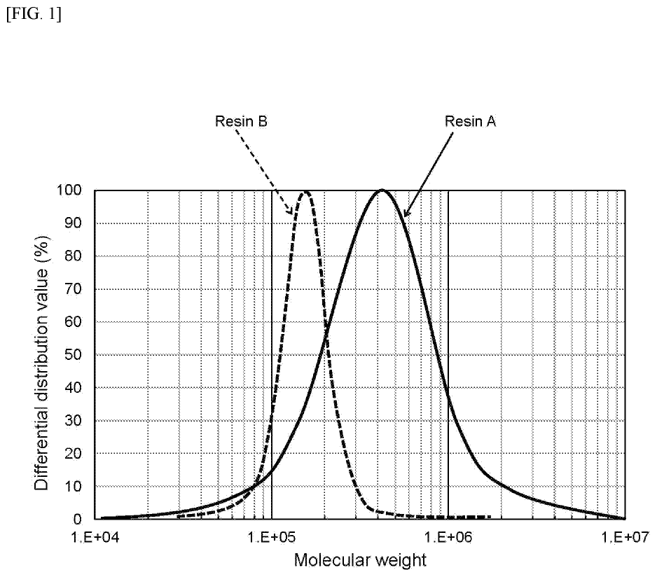

Next, the molecular weight distribution of each of the resin A and the resin B in this embodiment will be described with reference to FIG. 1. FIG. 1 is a diagram illustrating an example of the molecular weight distribution of each of the resin A and the resin B according to this embodiment. In FIG. 1, the vertical axis represents differential distribution values (frequencies) (%) normalized to 100.

The molecular weight distribution of each of the resin A and the resin B in FIG. 1 is measured, for example, by gel permeation chromatography (GPC) based on a calibration curve prepared using polystyrene (PS) as a standard sample. In other words, the term “molecular weight distribution” used herein refers to a distribution curve obtained by plotting the differential distribution values corresponding to the number of molecules against the molecular weight, as illustrated in FIG. 1, for example.

Hereinafter, Mw is a weight average molecular weight in the molecular weight distribution, and Mn is a number average molecular weight in the molecular weight distribution. Mw/Mn is a value called polydispersity index, and is defined as an index value (numerical value) indicating a degree of spread of the molecular weight distribution described above. The larger the Mw/Mn, the wider the molecular weight distribution.

As illustrated in FIG. 1, in this embodiment, the molecular weight distributions of the resin A and the resin B are different from each other. At least a part of the molecular weight distribution of the resin A overlaps with that of the resin B, for example. On the other hand, the molecular weight distribution of the resin A is relatively wider, whereas the molecular weight distribution of the resin B is relatively narrower. Such molecular weight distributions of the resin A and the resin B enable the resin A and the resin B to be homogeneously mixed. Accordingly, localization of each of the resin A and the resin B can be suppressed in the insulating layer 130. As a result, generation of fine voids and coarse crystals during the bending can be suppressed.

Specifically, a peak molecular weight in the molecular weight distribution of the resin A is, for example, 6×10⁴ or more and 6×10⁵ or less. When the peak molecular weight of the resin A is less than 6×10⁴, the resin A is brittle. This makes it difficult to homogeneously mix the resin A and the resin B. In contrast, by setting the peak molecular weight of the resin A to 6×10⁴ or more, embrittlement of the resin A can be suppressed. This enables the resin A and the resin B to be homogeneously mixed. On the other hand, when the peak molecular weight of the resin A is more than 6×10⁵, flowability is low, which makes it difficult to mold the insulating layer 130. In addition, the overlapping area of the molecular weight distribution of the resin A and the molecular weight distribution of resin B is narrower. This makes it difficult to homogeneously mix the resin A and the resin B. In contrast, by setting the peak molecular weight of the resin A to 6×10⁵ or less, flowability can be ensured and the insulating layer 130 can be stably molded. In addition, the molecular weight distribution of the resin A can be made to overlap with the molecular weight distribution of the resin B over a predetermined range. This enables the resin A and the resin B to be homogeneously mixed.

The Mw/Mn of the resin A is, for example, 3.0 or more and 8.0 or less. When Mw/Mn of the resin A is less than 3.0, it is difficult to mold the insulating layer 130. In contrast, by setting Mw/Mn of the resin A to 3.0 or more, the insulating layer 130 can be stably molded. On the other hand, when Mw/Mn of the resin A is more than 8.0, the molecular weight distribution of the resin A is excessively wider. Therefore, the compatibility between the resin A and the resin B partially deteriorates. This makes it difficult to homogeneously mix them. In contrast, by setting Mw/Mn of the resin A to 8.0 or less, excessive widening of the molecular weight distribution of the resin A can be suppressed while the molecular weight distribution of the resin A is made wider than the molecular weight distribution of the resin B. Therefore, generation of a portion where compatibility between the resin A and the resin B is poor can be suppressed. As a result, the resin A and the resin B can be homogeneously mixed.

On the other hand, a peak molecular weight in the molecular weight distribution of the resin B is 4×10⁴ or more and 4×10⁵ or less, for example. When the peak molecular weight of the resin B is less than 4×10⁴ or more than 4×10⁵, a non-homogeneous portion may be generated where only one of the resin A or the resin B clumps together. In contrast, by setting the peak molecular weight of the resin B to 4×10⁴ or more and 4×10⁵ or less, generation of the non-homogeneous portion can be suppressed where only one of the resin A or the resin B clumps together. That is, the resin A and the resin B can be homogeneously mixed.

Mw/Mn of the resin B is 1.1 or more and 3.0 or less, for example. When Mw/Mn of the resin B is less than 1.1, the molecular weight distribution of the resin B is excessively narrower. Therefore, a non-homogeneous portion where only one of the resin A or the resin B clumps together may be generated. In contrast, by setting Mw/Mn of the resin B to 1.1 or more, excessive narrowing of the molecular weight distribution of the resin B can be suppressed while the molecular weight distribution of the resin B is made narrower than the molecular weight distribution of the resin A. As a result, generation of a non-homogeneous portion where only one of the resin A or the resin B clumps together can be suppressed. That is, the resin A and the resin B can be homogeneously mixed. On the other hand, when Mw/Mn of the resin B is more than 3.0, the molecular weight distribution of the resin B is wider. The resin B, which is a mixture with a wide molecular weight distribution, can only be mixed with a portion of the resin A with a particular molecular weight. Therefore, a non-homogeneous portion where only one of the resin A or the resin B clumps together may be generated. In contrast, by setting Mw/Mn of the resin B to 3.0 or less, the molecular weight distribution of the resin B can be made narrower than the molecular weight distribution of the resin A. As a result, generation of a non-homogeneous portion where only one of the resin A or the resin B clumps together can be suppressed. As a result, the resin B which is a mixture with a narrow molecular weight distribution can be mixed homogeneously throughout the resin A, regardless of a local molecular weight in the resin A.

### (Elastic Modulus)

In this embodiment, an elastic modulus of the resin B is lower than an elastic modulus of the resin A, as described above. Further, in this embodiment, the resin A and the resin B satisfy the respective requirements for molecular weight distribution described above, which means that the resin A and the resin B satisfy the respective requirements for storage modulus measured by a dynamic mechanical analysis (DMA) described below.

In the following dynamic mechanical analysis, a storage modulus of a resin sample of interest is measured, for example, in a state where 0.08% of stretch and shrink is applied to the sample (in a state under application of oscillation of stretch and shrink with an amplitude of 0.08%) while temperature is raised from −50° C. to 100° C. In this event, a measuring frequency is set to 10 Hz, and a temperature rising rate is set to 10 ° C./min.

In the resin A which is a polypropylene-based resin, the elastic modulus increases as the molecular weight increases. A storage modulus of the resin A at 25° C. measured by the dynamic mechanical analysis is, for example, 600 MPa or more and 1200 MPa or less, based on the molecular weight distribution of the resin A described above. This makes it possible to obtain an effect equivalent to the effect of the resin A satisfying the requirements for molecular weight distribution described above. That is, the resin A and the resin B can be homogeneously mixed.

On the other hand, in the resin B which is a flexible resin, the correspondence between the molecular weight and the elastic modulus depends on whether the resin B is a styrene-based resin or not. In a case where the resin B is a non-styrene-based resin, the elastic modulus increases as the molecular weight increases. On the contrary, in a case where the resin B is a styrene-based resin, the elastic modulus decreases as the molecular weight increases.

Whichever the resin B is, a storage modulus of the resin B at 25° C. measured by the dynamic mechanical analysis is, for example, 1 MPa or more and 200 MPa or less, based on the molecular weight distribution of the resin B described above. This makes it possible to obtain an effect equivalent to the effect of the resin B satisfying the requirements for molecular weight distribution described above. That is, the resin A and the resin B can be homogeneously mixed.

Alternatively, for example, a ratio of the storage modulus of the resin A to the storage modulus of the resin B, at 25° C. measured by the dynamic mechanical analysis, is, 5 or more and 200 or less, based on the respective molecular weight distributions of the resin A and the resin B described above. This also makes it possible to obtain an effect equivalent to the effect of satisfying the requirements for molecular weight distribution described above.

### (Compounding Ratio)

Further, in this embodiment, it is preferable that a compounding ratio of the resin A and the resin B satisfies the following requirements.

Specifically, the content of the resin A is, for example, 52 parts by mass or more and 95 parts by mass or less with respect to the total content of the resin A and the resin B being 100 parts by mass.

When the content of the resin A is less than 52 parts by mass, an amount of the resin B which is a flexible resin is relatively larger. Therefore, a low-elastic region in which the resin B is locally concentrated is likely to be generated. As a result, fine voids may be generated at least either at the interface between the high-elastic region and the low-elastic region or within the low-elastic region during the bending. In contrast, by setting the content of the resin A to 52 parts by mass or more, excessive generation of the low-elastic region can be suppressed. Accordingly, generation of fine voids at least either at the interface between the high-elastic region and the low-elastic region or within the low-elastic region can be suppressed during the bending.

On the other hand, when the content of the resin A is more than 95 parts by mass, an amount of the resin A which is a propylene-based resin is excessively larger than that of the resin B. Therefore, a high-elastic region in which the resin A is locally concentrated is likely to be generated. As a result, fine voids may be generated due to intercrystalline separation in the high-elastic region during the bending. In contrast, by setting the content of the resin A to 95 parts by mass or less, excessive generation of the high-elastic region can be suppressed. As a result, generation of fine voids due to the intercrystalline separation in the high-elastic region can be suppressed during the bending.

### (Other Additives)

The resin composition molded body may contain, for example, an antioxidant, a copper inhibitor, a lubricant, and a coloring agent, in addition to the above-described resin components.

However, it is preferable that the resin composition molded body of this embodiment contains only a small amount of the additive, which functions as a nucleating agent for producing the propylene crystals, for example. Examples of the additive that functions as the nucleating agent include inorganic or organic substances such as flame retardants. Specifically, it is preferable that the content of the additive that functions as the nucleating agent is, for example, less than 1 part by mass with respect to the total content of the propylene-based resin and the low-crystallinity resin being 100 parts by mass. Accordingly, the generation of unexpected abnormal crystallization due to the nucleating agent can be suppressed, and the amount of crystals can be easily controlled.

### (2) Power Cable

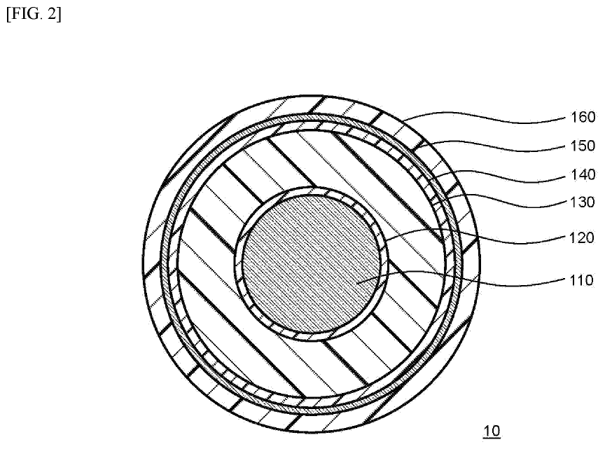

Next, with reference to FIG. 2, the power cable of this embodiment will be described. FIG. 2 is a cross-sectional diagram orthogonal to an axial direction of a power cable according to this embodiment.

The power cable 10 of this embodiment is configured as a so-called solid insulation power cable. In addition, the power cable 10 of this embodiment is configured, for example, to be laid on the ground (in a pipeline), under water, or on the bottom of water. The power cable 10 is used, for example, for AC.

Specifically, the power cable 10 includes, for example, a conductor 110, an internal semiconductive layer 120, an insulating layer 130, an external semiconductive layer 140, a shielding layer 150, and a sheath 160.

### (Conductor (Conductive Part))

The conductor 110 is configured by twisting together a plurality of conductor core wires (conductive core wires) including, for example, pure copper, copper alloy, aluminum, aluminum alloy, or the like.

### (Internal Semiconductive Layer)

The internal semiconductive layer 120 is provided so as to cover the outer circumference of the conductor 110. In addition, the internal semiconductive layer 120 has semiconductivity and is configured to suppress electric field concentration on the surface side of the conductor 110. The internal semiconductive layer 120 includes, for example, at least any one of ethylene-based copolymers such as ethylene-ethyl acrylate copolymers, ethylene-methyl acrylate copolymers, ethylene-butyl acrylate copolymers, and ethylene-vinyl acetate copolymers, olefinic elastomers, the above-described low-crystallinity resins and the like, together with conductive carbon black.

### (Insulating Layer)

The insulating layer 130 is provided so as to cover the outer circumference of the internal semiconductive layer 120, and configured as the above-described resin composition molded body. For example, the insulating layer 130 is formed through extrusion molding using the resin composition, as described above.

### (External Semiconductive Layer)

The external semiconductive layer 140 is provided so as to cover the outer circumference of the insulating layer 130. In addition, the external semiconductive layer 140 has semiconductivity and is configured to suppress electric field concentration between the insulating layer 130 and the shielding layer 150. The external semiconductive layer 140 is constituted by the same material as the internal semiconductive layer 120, for example.

### (Shielding Layer)

The shielding layer 150 is provided so as to cover the outer circumference of the external semiconductive layer 140. The shielding layer 150 is, for example, configured by winding a copper tape, or configured as a wire shield formed by winding a plurality of soft copper wires. A tape including rubberized cloth or the like as a raw material may be wound inside or outside the shielding layer 150.

### (Sheath)

The sheath 160 is provided so as to cover the outer circumference of the shielding layer 150. The sheath 160 is constituted by polyvinyl chloride or polyethylene, for example.

For an underwater cable or a subaqueous cable, the power cable 10 of this embodiment may have a metallic water shielding layer such as a so-called alclad or an iron wire armoring outside the shielding layer 150.

On the other hand, the power cable 10 of this embodiment does not have to include a water shielding layer outside the shielding layer 150, for example. That is, the power cable 10 of this embodiment may have an imperfect water shielding structure.

### (Specific Dimensions and the Like)

Specific dimensions of the power cable 10 are not particularly limited. For example, the diameter of the conductor 110 is 5 mm or more and 60 mm or less, the thickness of the internal semiconductive layer 120 is 0.5 mm or more and 3 mm or less, the thickness of the insulating layer 130 is 3 mm or more and 35 mm or less, the thickness of the external semiconductive layer 140 is 0.5 mm or more and 3 mm or less, the thickness of the shielding layer 150 is 0.1 mm or more and 5 mm or less, and the thickness of the sheath 160 is 1 mm or more. The AC voltage applied to the power cable 10 of this embodiment is, for example, 20 kV or more.

### (3) Cable Properties

In this embodiment, as described above, requirements for the respective molecular weight distribution, elastic modulus, and compounding ratio of the resin A and the resin B are satisfied to obtain the properties of the insulating layer 130 described below.

### (Micro-Region Elasticity)

The possibility of generation of fine voids and coarse crystals during the bending described above cannot be grasped by simply measuring the elastic modulus of the molded body by the dynamic mechanical analysis (DMA) or the like as a measurement of a macro hardness (macroscopic hardness) during the bending.

Therefore, the present inventors have studied intensively, and attempted performing a micro-region elasticity measurement of the molded body as a measurement of a micro hardness (microscopic hardness). As a result, the present inventors have found that the possibility of generation of fine voids and coarse crystals during the bending can be grasped.

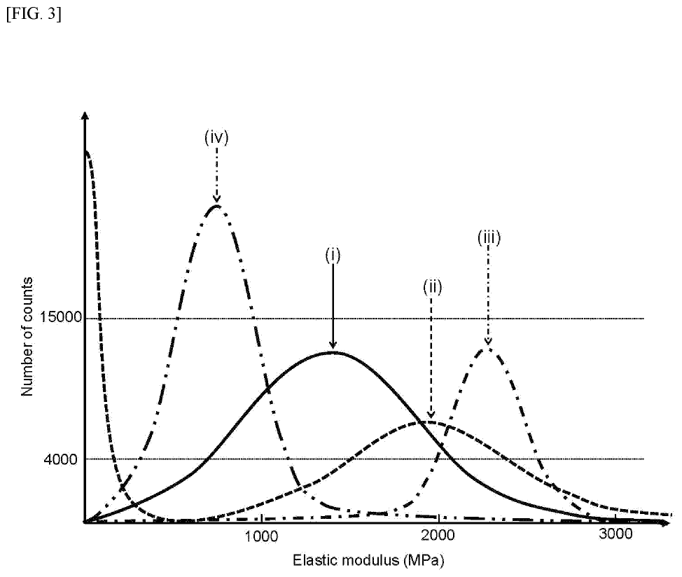

With reference to FIG. 3, the micro-region elasticity measurement will be described below. FIG. 3 is a diagram illustrating an exemplary result of the micro-region elasticity measurement.

The “micro-region elasticity measurement” in FIG. 3 is performed using a scanning probe microscope (SPM). In the micro-region elasticity measurement, the elastic modulus is measured under conditions of tapping within a 10 μm square area of the molded body 60000 times at 25° C. with a cantilever having a tip that is made of silicon (single crystal) and has a radius of curvature of 1 nm or more and less than 20 nm, for example. As the molded body subjected to the measurement, for example, a sheet having a predetermined thickness, cut out from a central portion of the insulating layer 130 in the thickness direction is used. Such a micro-region elasticity measurement provides a distribution of number of counts with respect to the elastic modulus of the molded body.

The insulating layer 130 of this embodiment satisfies a first requirement, a second requirement, and a third requirement described below in the distribution of number of counts with respect to the elastic modulus of the insulating layer 130 determined by the micro-region elasticity measurement, for example.

First, comparative examples that do not satisfy at least any one of the first requirement, the second requirement, and the third requirement will be described.

In a comparative example, two or more peaks may appear in a region in which the number of counts amounts to 4000 or more as illustrated in FIG. 3(ii), for example. This case corresponds to a case where the resin A and the resin B are not homogeneously mixed, and at least either of the resin A or the resin B is localized. In this case, fine voids and coarse crystals may be generated during the bending.

In another comparative example, the elastic modulus at the peak of the normal distribution may exceed 2000 MPa, for example, even where only one peak of the normal distribution exists, as illustrated in FIG. 3(iii). This case corresponds to a case where a high-elastic region is generated in which the content of the resin A is high and the resin A is concentrated locally. Again, fine voids and coarse crystals may be generated during the bending.

In another comparative example, the number of counts at the peak of the normal distribution may amount to 25% or more of the total number of tapping (i.e., 15000 or more), even where there is only one peak of the normal distribution and the elastic modulus at the peak is 2000 MPa or less, as illustrated in FIG. 3(iv), for example. This case corresponds to a case where the elastic modulus of the resin B is excessively low and the resin A and the resin B are not homogeneously mixed. Again, fine voids and coarse crystals may be generated during the bending.

In contrast, in the first requirement of this embodiment, a normal distribution with only one peak appears in a region in which the number of counts is 4000 or more, as illustrated in FIG. 3(i), for example. In the second requirement, the elastic modulus at the peak of the normal distribution is 2000 MPa or less. In the third requirement, the number of counts at the peak of the normal distribution is less than 25% of the total number of tapping.

As described above, in this embodiment, the distribution of the elastic moduli shifts toward the lower elastic moduli and is widely spread from lower elastic moduli to higher elastic moduli, in a micro-region of the insulating layer 130. That is, since the resin A and the resin B are homogeneously mixed, the hardness is homogeneous even in a micro-region of the molded body. Accordingly, generation of fine voids and coarse crystals during the bending can be suppressed.

In the second requirement, the lower limit of the elastic modulus at the peak of the normal distribution is not limited but, for example, 500 MPa, corresponding to the elastic modulus in a case with less propylene-based resin. In the third requirement, the number of counts at the peak of the normal distribution is not limited. However, when the first requirement is satisfied, the lower limit of the number of counts in the third requirement will not be smaller than the number of counts (4000) used as a basis for the first requirement. Therefore, the lower limit of the number of counts in the third requirement is, for example, 6.7% of the total number of tapping.

### (Bending Resistance)

In this embodiment, the insulating layer 130 that satisfies all the requirements in the micro-region elasticity measurement described above has a resistance to a predetermined bending test.

The “bending test” herein includes, for example, a first step of bending the power cable 10 so that a bending ratio of a bending radius of the power cable 10 (bending radius of the molded body) to an outer diameter of the insulating layer 130 (outer diameter of the molded body) is 7 or less, and a second step of bending the power cable in a direction opposite to a bending direction in the first step at the same bending ratio as the bending ratio in the first step. In a bending test according to a normal cable standard, the bending ratio of the bending radius of the power cable to the outer diameter of the insulating layer is set to about 20, for example. In contrast, the bending ratio in the bending test in this embodiment is smaller than the bending ratio in the bending test according to the normal cable standard. Therefore, a bending stress applied to the insulating layer 130 in this embodiment is increased. Thus, the bending test in this embodiment is considered to be a severe test for the insulating layer 130.

As an evaluation for resistance to the bending test, the presence or absence of voids and coarse crystals in the insulating layer 130 is evaluated. Evaluation of voids is performed, for example, using a scanning electrode microscope (SEM). Evaluation of coarse crystals is performed, for example, using an optical microscope.

In this embodiment, there are no voids with a maximum length of 1 μm or more nor crystals with a maximum length of more than 10 μm in the insulating layer 130 after the above-described bending test. Thus, the degradation of the insulation after the bending can be reduced by suppressing generation of fine voids and coarse crystals during the bending.

### (Insulation)

In this embodiment, the AC breakdown electric field strength of the insulating layer 130 at an ordinary temperature (e.g., 25° C.) before the above-described bending test is 60 kV/mm or more, for example. More specifically, the AC breakdown electric field is 60 kV/mm or more when a voltage is applied to a sample with a thickness of 0.2 mm under conditions that, at an ordinary temperature, an AC voltage with a commercial frequency (e.g., 60 Hz) is applied at 10 kV for 10 minutes, and thereafter a cycle including raising the AC voltage by a 1 kV increment and applying the raised voltage for 10 minutes is repeated.

Further, in this embodiment, the AC breakdown electric field is maintained at high level even after the above-described bending test.

That is, in this embodiment, the AC breakdown electric field strength of the insulating layer 130 at an ordinary temperature (e.g., 25° C.) after the above-described bending test is 60 kV/mm or more, for example. Note that the method of testing the AC breakdown electric field strength after the bending test is similar to that before the above-described bending test.

### (4) Method of Producing Power Cable

Next, a method of producing the power cable of this embodiment will be described. Hereinafter, the step is abbreviated as “S”.

### (S100: Resin Composition Preparation Step)

First, a resin composition containing propylene units is prepared.

In this embodiment, a mixed material is formed by mixing (kneading) a resin component containing the resin A which is a propylene-based resin and the resin B which is a flexible resin, and other additive (antioxidant and the like), using a mixer. Examples of the mixer include an open roll, a Banbury mixer, a pressure kneader, a single-screw mixer, and a multi-screw mixer.

In this event, the resin A and the resin B are used which satisfy at least either of the requirements for molecular weight distribution or elastic modulus described above.

Specifically, the peak molecular weight in the molecular weight distribution of the resin A is set to 6×10⁴ or more and 6×10⁵ or less, and Mw/Mn of the resin A is set to 3.0 or more and 8.0 or less. Further, the peak molecular weight in the molecular weight distribution of the resin B is set to 4×10⁴ or more and 4×10⁵ or less, and Mw/Mn of the resin B is set to 1.1 or more and 3.0 or less.

Alternatively, the storage modulus of the resin A at 25° C. measured by the dynamic mechanical analysis is set to 600 MPa or more and 1200 MPa or less, and the storage modulus of the resin B at 25° C. measured by the dynamic mechanical analysis is set to 1 MPa or more and 200 MPa or less.

Alternatively, a ratio of the storage modulus of the resin A to the storage modulus of the resin B, at 25° C. measured by the dynamic mechanical analysis, is set to 5 or more and 200 or less.

In this case, a content of the resin A is set to 52 parts by mass or more and 95 parts by mass or less with respect to a total content of the resin A and the resin B being 100 parts by mass.

After the mixed material is formed, the mixed material is granulated using an extruder. As a result, pellet-shaped resin compositions, which are to constitute the insulating layer 130, are formed. Note that the steps from mixing to granulation may be collectively performed using a twin-screw extruder with high kneading performance.

### (S200: Conductor Preparation Step)

Meanwhile, the conductor 110 formed by twisting a plurality of conductor core wires together is prepared.

### (S300: Cable Core Formation Step (Extrusion Step, Insulating Layer Formation Step))

After the resin composition preparation step S100 and the conductor preparation step S200 are completed, the insulating layer 130 is formed using the resin composition to cover the outer circumference of the conductor 110 at the thickness of 3 mm or more.

At this time, in this embodiment, by using the above-described resin composition, the insulating layer 130 is formed so as to satisfy the first requirement, the second requirement, and the third requirement in the distribution of the number of counts with respect to the elastic modulus determined by the micro-region elasticity measurement.

At this time, in this embodiment, by using the above-described resin composition, the insulating layer 130 is formed so that there are no voids with a maximum length of 1 μm or more nor crystals with a maximum length of more than 10 μm in the insulating layer 130 after the above-described bending test.

At this time, in this embodiment, the internal semiconductive layer 120, the insulating layer 130, and the external semiconductive layer 140 are formed simultaneously using a three-layer co-extruder, for example.

Specifically, for example, a resin composition for the internal semiconductive layer is charged into an extruder A of the three-layer co-extruder, the extruder A forming the internal semiconductive layer 120.

The pellet-like resin composition described above is charged into an extruder B forming the insulating layer 130. The set temperature of the extruder B is set to a temperature higher than the desired melting point by 10° C. or more and 50° C. or less. It is preferable to appropriately adjust the set temperature based on a linear velocity and an extrusion pressure.

A resin composition for the external semiconductive layer is charged into an extruder C forming the external semiconductive layer 140, the rein composition including materials similar to those of the resin composition for the internal semiconductive layer charged into the extruder A.

Then, the respective extrudates from the extruders A to C are guided to a common head, and the internal semiconductive layer 120, the insulating layer 130, and the external semiconductive layer 140, outwardly from the inside, are simultaneously extruded on the outer circumference of the conductor 110. Accordingly, an extruded material that is to be a cable core is formed.

The extruded material is then cooled, for example, with water.

The cable core constituted by the conductor 110, the internal semiconductive layer 120, the insulating layer 130, and the external semiconductive layer 140 is formed through the cable core formation step S300 described above.

### (S400: Shielding Layer Formation Step)

After the cable core is formed, the shielding layer 150 is formed outside the external semiconductive layer 140, for example, by winding a copper tape therearound.

### (S500: Sheath Formation Step)

After the shielding layer 150 is formed, vinyl chloride is charged into an extruder, and extruded from the extruder to form a sheath 160 on the outer circumference of the shielding layer 150.

As described above, the power cable 10 as the solid insulation power cable is produced.

(5) Effects According to this Embodiment

According to this embodiment, one or more effects described below are achieved.

(a) In this embodiment, at least a part of the molecular weight distribution of the resin A overlaps with that of the resin B. On the other hand, the molecular weight distribution of the resin A is relatively wider, whereas the molecular weight distribution of the resin B is relatively narrower. Accordingly, the resin A and the resin B can be homogeneously mixed.

Next, a case where each of the resin A and the resin B does not satisfy the requirements for molecular weight distribution described above will be discussed.

An example of the case where the requirements for molecular weight distribution described above are not satisfied is a case where the molecular weight distribution of the resin A does not overlap with that of the resin B. In this case, the compatibility between the resin A and the resin B is low and they may fail to be sufficiently mixed with each other.

A case is considered where both of the molecular weight distribution of the resin A and the molecular weight distribution of the resin B are wider even though the molecular weight distribution of the resin A overlaps with the molecular weight distribution of the resin B. In this case, it is expected that the resin A and the resin B are homogeneously mixed with each other according to their wide molecular weight distributions. In fact, however, the resin A and the resin B will be in heterogeneous states, contrary to the expectation described above. In other words, a portion may be generated where the resin A and the resin B fail to be mixed with each other, resulting in at least either of the resin A or the resin B may be localized. For example, it is conceivable that all of the resin B could be concentrated toward and mixed with a portion of the resin A having a certain molecular weight.

In contrast, in this embodiment, due to each molecular weight distribution of the resin A and the resin B described above, the resin B having a narrow molecular weight distribution can be mixed homogeneously throughout the resin A, regardless of a local molecular weight in the resin A. As a result, in the insulating layer 130, localization of each of the resin A and the resin B can be suppressed.

By suppressing the localization of each of the resin A and the resin B, the flexible portions and the hard portions can be evenly distributed while the elastic modulus is shifted toward the lower elastic moduli, even in the micro-region of the insulating layer 130. Accordingly, generation of fine voids and coarse crystals during the bending can be suppressed. As a result, it is possible to reduce the degradation in the insulation of the insulating layer 130 after the bending.

(b) In this embodiment, the peak molecular weight in the molecular weight distribution of the resin A is 6×10⁴ or more and 6×10⁵ or less. This allows the resin A and the resin B to be homogeneously mixed. Further, Mw/Mn of the resin A is 3.0 or more and 8.0 or less. By setting Mw/Mn of the resin A to 3.0 or more, the insulating layer 130 can be stably molded. Further, by setting Mw/Mn of the resin A to 8.0 or less, excessive widening of the molecular weight distribution of the resin A can be suppressed while the molecular weight distribution of the resin A is made wider than the molecular weight distribution of the resin B. Therefore, generation of a portion where compatibility between the resin A and the resin B is poor can be suppressed. As a result, the resin A and the resin B can be homogeneously mixed.

The peak molecular weight in the molecular weight distribution of the resin B is 4×10⁴ or more and 4×10⁵ or less. This allows the resin A and the resin B to be homogeneously mixed. Further, Mw/Mn of the resin B is 1.1 or more and 3.0 or less. By setting Mw/Mn of the resin B to 1.1 or more and 3.0 or less, generation of a non-homogeneous portion can be suppressed where only one of the resin A or the resin B clumps together. That is, the resin A and the resin B can be homogeneously mixed.

As described above, since the resin A and the resin B satisfy the requirements for molecular weight distribution described above, localization of each of the resin A and the resin B can be suppressed in the insulating layer 130. As a result, generation of fine voids and coarse crystals during the bending can be suppressed.

(c) In this embodiment, based on the above-described molecular weight distribution of the resin A, the storage modulus of the resin A at 25° C. is 600 MPa or more and 1200 MPa or less. This makes it possible to obtain an effect equivalent to the effect of the resin A satisfying the requirements for molecular weight distribution described above. That is, the resin A and the resin B can be homogeneously mixed.

Further, based on the above-described molecular weight distribution of the resin B, the storage modulus of the resin B at 25° C. is 1 MPa or more and 200 MPa or less. This makes it possible to obtain an effect equivalent to the effect of the resin B satisfying the requirements for molecular weight distribution described above. That is, the resin A and the resin B can be homogeneously mixed.

Alternatively, based on the respective molecular weight distributions of the resin A and the resin B described above, a ratio of the storage modulus of the resin A to the storage modulus of the resin B at 25° C. is 5 or more and 200 or less. This also makes it possible to obtain an effect equivalent to the effect of satisfying the requirements for molecular weight distribution described above.

(d) In this embodiment, the content of the resin A is 52 parts by mass or more and 95 parts by mass or less with respect to the total content of the resin A and the resin B being 100 parts by mass. By setting the content of the resin A to 52 parts by mass or more, excessive generation of the low-elastic region can be suppressed. As a result, generation of fine voids at least either of at the interface between the high-elastic region and the low-elastic region, or in the low-elastic region during the bending can be suppressed. On the other hand, by setting the content of the resin A to 95 parts by mass or less, excessive generation of the high-elastic region can be suppressed. As a result, generation of fine voids due to the intercrystalline separation in the high-elastic region can be suppressed during the bending.

(e) In this embodiment, since the resin A and the resin B satisfy the above-described requirements for molecular weight distribution, elastic modulus, and compounding ratio, the insulating layer 130 satisfies the first requirement, the second requirement, and the third requirement described above in the distribution of number of counts with respect to the elastic modulus of the insulating layer 130 determined by the micro-region elasticity measurement. That is, in the insulating layer 130 of this embodiment, the distribution of the elastic moduli in the micro-region is widely spread from lower elastic moduli to higher elastic moduli while shifting toward the lower elastic moduli. In other word, since the resin A and the resin B are homogeneously mixed, the flexible portions and the hard portions can be evenly distributed even in the micro-region of the molded body. Accordingly, generation of fine voids and coarse crystals during the bending can be suppressed.

(f) In this embodiment, there are no voids with a maximum length of 1 μm or more nor crystals with a maximum length of more than 10 μm in the insulating layer 130 after the above-described bending test. Thus, by suppressing generation of fine voids and coarse crystals during the bending, the local electric field concentration upon application of the high electric field can be suppressed. As a result, degradation of the insulation after the bending can be suppressed.

### Other Embodiments of Disclosure

Although embodiments according to the present disclosure have been described in detail above, the present disclosure is not limited to the above-described embodiments, and various modifications can be made without departing from the gist thereof.

In the above-described embodiment, an explanation is given for the resin composition molded body as the insulating layer obtained by mechanical mixing and extrusion molding, but the resin composition molded body may be the one obtained by polymerization and extrusion molding.

In the above-described embodiment, an explanation is given for a case where the power cable 10 may have no water shielding layer, but the present disclosure is not limited to the case. The power cable 10 may have a simple water shielding layer. Specifically, the simple water shielding layer is made of, for example, a metallic laminated tape. Metallic laminated tape includes a metal layer made of aluminum, copper, or the like, and an adhesive layer provided on one or both sides of the metal layer, for example. The metal laminated tape is wrapped longitudinally around the outer circumference of a cable core (outer circumference outward of the external semiconductive layer) so as to surround the cable core, for example. Note that this water shielding layer may be provided outside the shielding layer, or may also serve as the shielding layer. This configuration can reduce the cost of the power cable 10.

In the above-described embodiments, an explanation is given for a case where the power cable 10 is configured to be laid on the ground, under water, or on the bottom of water, but the present disclosure is not limited to the case. For example, the power cable 10 may be configured as a so-called overhead wire (overhead insulated wire).

In the above-described embodiment, three layers are extruded simultaneously in the cable core formation step S300, but they may be individually extruded.

### EXAMPLES

Next, examples according to the present disclosure will be described. These examples are illustrative of the present disclosure, and the present disclosure is not limited by these examples.

### (1) Production of Power Cable

First, a predetermined resin composition was mixed using a Banbury mixer and granulated into pellets by an extruder. Then, a conductor with a cross-sectional area of 100 mm² was prepared. After the conductor was prepared, a resin composition for an internal semiconductive layer containing ethylene-ethyl acrylate copolymer, the above-described resin composition, and a resin composition for an external semiconductive layer made of the same material as the resin composition for an internal semiconductive layer were respectively introduced into the extruders A to C. The respective extrudates from the extruders A to C are guided to a common head, and the internal semiconductive layer, the insulating layer, and the external semiconductive layer, outwardly from the inside, are simultaneously extruded on the outer circumference of the conductor. At this time, the thicknesses of the internal semiconductive layer, the insulating layer, and the external semiconductive layer were 0.5 mm, 3.5 mm, and 0.5 mm, respectively. After extrusion, an extrudate was cooled with water. As a result, a power cable of each of the samples A1 to A7, and B1 to B9, including the conductor, the internal semiconductive layer, the insulation layer, and the external semiconductive layer, outwardly from the center, was produced.

### Samples A1 to A7, B1 to B9

### (Molding Method)

### Extrusion Molding

Extrusion temperature: 170° C.
Thickness of insulating layer: 3.5 mm
Outer diameter of final power cable: 20.3 mm

### (Resin A)

Content: 40 to 100 parts by mass
(where the total content of the resin A and the resin B is 100 parts by mass)
PP1 to PP3: propylene random polymer (random PP)
(hereinafter, numerical values corresponding to PP1 to PP3 appear in this order)
Tacticity: isotactic
Peak molecular weight in terms of styrene: 230000, 480000, and 720000
Mw/Mn: 6.7, 6.2, and 5.1
Storage modulus of PP itself at 25° C. measured by dynamic mechanical analysis: 850 MPa, 1050 MPa, and 1300 MPa
Note that PP1 contains 10 mass % of EPR.

### (Resin B)

Content: 0 to 60 parts by mass
Materials:
EPR1, EPR2: Ethylene-propylene rubber (EPR)
(hereinafter, numerical values corresponding to EPR1, EPR2 appear in this order)
Ethylene content: 52 mass %, 68 mass %
Peak molecular weight in terms of styrene: 200000, 700000
Mw/Mn: 2.3, 2.5
Storage modulus of EPR itself at 25° C. measured by dynamic mechanical analysis: 40 MPa,
210 MPa
VLDPE1, VLDPE2: Very low density polyethylene
(hereinafter, numerical values corresponding to VLDPE1, VLDPE2 appear in this order)
Copolymer of ethylene and 1-butene, copolymer of ethylene and 1-octene
1-Butene content: 25 mass %, 1-octene content: 10 mass %
Peak molecular weight in terms of styrene: 120000, 270000
Mw/Mn: 1.4, 1.7
Storage modulus of VLDPE itself at 25° C. measured by dynamic mechanical analysis: 80 MPa, 180 MPa
SEBS1 to SEBS3: Hydrogenated styrene-butadiene-styrene block copolymer
(hereinafter, numerical values corresponding to SEBS1 to SEBS3 appear in this order)
Styrene content: 40 mass %, 20 mass %, 10 mass %
Peak molecular weight in terms of styrene: 30000, 70000, 150000
Mw/Mn: 1.2, 1.1, 1.1
Storage modulus of SEBS itself at 25° C. measured by dynamic mechanical analysis:330 MPa, 70 MPa, 5 MPa
Butyl rubber 1, butyl rubber 2: Isobutylene isoprene copolymer
(hereinafter, numerical values corresponding to butyl rubber 1, butyl rubber 2 appear in this order)
Peak molecular weight in terms of styrene: 600000, 800000
Mw/Mn: 5.2, 5.2
Storage modulus of butyl rubber itself at 25° C. measured by dynamic mechanical analysis: 230 MPa, 350 MPa
Polybutene
Peak molecular weight in terms of styrene: 10000
Mw/Mn: 2.1
Storage modulus of polybutene itself at 25° C. measured by dynamic mechanical analysis:0.1 MPa
Note that only polybutene is liquid at 25° C.

### (2) Evaluation

### Resin Evaluation

The following analyses were performed on each of the above-described resins A and B.

### (Molecular Weight Distribution)

The molecular weight distribution of each of the resin A and the resin B was measured by GPC under the following conditions based on a calibration curve prepared using PS as a standard sample.
Apparatus: HLC-8321GPC/HT manufactured by TOSOH CORPORATION
Eluent: o-Dichlorobenzene
Temperature: 145° C.
Concentration: 0.1 wt %/vol %
Flow rate: 1.0 ml/min
Note that the calibration curve of PS was prepared based on the results within the molecular weight range of 1000 or more and 5500000 or less.

### (Storage Modulus)

Each of the resin A and the resin B was used by itself to prepare a press sheet for evaluation. The dynamic mechanical analysis (DMA) was performed on the press sheet of the resin of interest. Specifically, the storage modulus was measured on the press sheet in a state where 0.08% of stretch and shrink is applied to the press sheet while temperature was raised from - 50° C. to 100° C. In this event, measuring frequency was set to 10 Hz. Further, temperature rising rate was set to 10 ° C./min. As a result of the measurement, the storage moduli at 25° C. were compared.

### Post-Production Evaluation

Further, for each of the above-described samples A1 to A7, and B1 to B9, two power cables were produced, one of them was evaluated immediately after production, and the other was evaluated after the bending test.

### (i) Evaluation Immediately After Production (Before Bending Test)

### (Sample Collection)

The insulating layer of the power cable of each of the samples A1 to A7, and B1 to B9 was thinly sliced along the circumferential direction of the individual power cable, and a sheet was taken from a central portion of the insulating layer in the thickness direction. The thickness of the sheet was 0.5 mm.

### (Observation of Voids)

The above-described sheet of the insulating layer was observed using SEM. When voids were present in the observed image, the maximum length of the void was measured. As a result, a sheet of the insulating layer in which voids having the maximum length of 1 μm or more were not present was evaluated as “A (good)”, and a sheet of the insulating layer in which voids having the maximum length of 1 μm or more were present was evaluated as “B (bad)”.

### (Observation of Crystals)

The above-described sheet of the insulating layer was observed using an optical microscope. When crystals were present in the observed image, the maximum length of the crystals was measured. In a case where crystals overlapped with each other, which made it difficult to measure the maximum length of the crystal on the lower side, the crystals exposed on the upper side were measured. As a result, a sheet of the insulating layer in which voids having the maximum length of more than 10 μm were not present was evaluated as “A (good)”, and a sheet of the insulating layer in which voids having the maximum length of more than 10 μm were present was evaluated as “B (bad)”.

### (Storage Modulus)

The dynamic mechanical analysis was performed on the sheet of the above-described insulating layer, in the same manner as in the measurement of each of the resin A and the resin B itself. Thus, the storage modulus of the molded body was evaluated.

### (AC Breakdown Test)

A voltage was applied to the sheet of the insulating layer under conditions that, at an ordinary temperature (25° C.), an AC voltage with a commercial frequency (e.g., 60 Hz) was applied at 10 kV for 10 minutes, and thereafter a cycle including raising the AC voltage by 1 kV increment and applying the raised voltage for 10 minutes was repeated. The electric field strength when the sheet of the insulating layer underwent dielectric breakdown was measured. As a result, a sheet with the AC breakdown strength of 60 kV/mm or more was evaluated as good, and a sheet with the AC breakdown strength of less than 60 kV/mm was evaluated as bad.

### (Micro-Region Elasticity Measurement)

A scanning probe microscope (SPM) was used to perform the micro-region elasticity measurement on the sheet of the insulating layer. As a SPM apparatus, MultiMode 8 manufactured by Bruker Corporation was used. In the micro-region elasticity measurement, the elastic modulus was measured under conditions of tapping within a 10 μm square area of the sheet 60000 times at 25° C. with a cantilever having a tip that was made of silicon and had a radius of curvature of less than 20 nm. Thus, a distribution of the number of counts with respect to the elastic modulus of the sheet was obtained.

As a result, a sheet satisfying the first requirement, the second requirement, and the third requirement described below was evaluated as good, and a sheet failing to satisfy any one of them was evaluated as bad:
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

In Table 2 which follows, when the first requirement is not satisfied, entries of the second and third requirement columns are omitted.

### (ii) Evaluation After the Bending Test

### (Bending Test: 7D Bending Test)

For the power cable of each of the above-described samples A1 to A7, and B2 to B9, bending test was performed. Note that the sample B1 was not evaluated after the bending test because it had been evaluated as bad immediately after the production.

In the first step of the bending test, the power cable with an outer diameter of 20.3 mm was pressed along a half circumference of a ring made of SUS with a radius of 140 mm. That is, the power cable was bent so that a bending ratio of the bending radius of the power cable to the outer diameter of the insulating layer (outer diameter of the power cable) was 7 or less. Thereafter, in the second step, the power cable was bent in a direction opposite to the bending direction in the first step at the same bending ratio as the bending ratio in the first step.

### (Sample Collection)

From the power cable of each of the samples A1 to A7, and B2 to B9 after the bending test, a sheet of the insulating layer was taken, in the same manner as in the above-described evaluation immediately after production.

### (Observation of Voids and Crystals)

On the sheet of the insulating layer taken after the bending test, observation and evaluation of voids and crystals were performed, in the same manner as in the above-described evaluation immediately after production.

### (Alternating Current Breakdown Test (AC Breakdown Test))

On the sheet of the insulating layer taken after the bending test, the AC breakdown test was performed, in the same manner as in the above-described evaluation immediately after production.

### (3) Results

With reference to the following Table 1 and Table 2, the evaluation result of each sample will be described. In Table 1 and Table 2, the elastic modulus at the peak of the SPM measurement results is referred to as a “peak elastic modulus”, and the number of counts at the peak is referred to as a “peak number of counts”.

TABLE 1

| | | Peak molecular | | Storage | | | | | | | |
|---|---|---|---|---|---|---|---|---|---|---|---|
| | | weight in terms | | modulus (MPa) | | | | | | | |
| | | of styrene | Mw/Mn | at 25° C. | A1 | A2 | A3 | A4 | A5 | A6 | A7 |
| Resin A | PP1 | 230000 | 6.7 | 850 | 90 | 70 | 55 | | | | 95 |
| | PP2 | 480000 | 6.2 | 1050 | | | | 70 | 60 | 52 | |
| | PP3 | 720000 | 5.1 | 1300 | | | | | | | |
| Resin B | EPR1 | 200000 | 2.3 | 40 | 10 | | | 30 | | | |
| | EPR2 | 700000 | 2.5 | 210 | | | | | | | |
| | VLDPE1 | 120000 | 1.4 | 80 | | | | | 40 | | |
| | VLDPE2 | 270000 | 1.7 | 180 | | | | | | 48 | |
| | SEBS1 | 30000 | 1.2 | 330 | | | | | | | |
| | SEBS2 | 70000 | 1.1 | 70 | | | 45 | | | | |
| | SEBS3 | 150000 | 1.1 | 5 | | 30 | | | | | 5 |
| | Butyl | 600000 | 5.2 | 230 | | | | | | | |
| | rubber 1 | | | | | | | | | | |
| | Butyl | 800000 | 5.2 | 350 | | | | | | | |
| | rubber 2 | | | | | | | | | | |
| | Polybutene | 10000 | 2.1 | 0.1 | | | | | | | |
| | (liquid) | | | | | | | | | | |

| Storage modulus of resin A/storage modulus of resin B | | | 21 | 170 | 12 | 26 | 13 | 6 | 170 |
|---|---|---|---|---|---|---|---|---|---|
| Immediately | Presence of absence of voids | | A | A | A | A | A | A | A |
| after | Presence or absence of coarse crystals | | A | A | A | A | A | A | A |
| production | Storage modulus of | MPa | 750 | 560 | 460 | 710 | 620 | 590 | 780 |
| | molded body at 25° C. | | | | | | | | |
| | AC Breakdown | kV/mm | 75 | 71 | 67 | 73 | 69 | 62 | 77 |
| | electric field | | | | | | | | |

| | | | | | | | | |
|---|---|---|---|---|---|---|---|---|
| SPM | Number of normal distribution | 1 | 1 | 1 | 1 | 1 | 1 | 1 |

| | | | | | | | | | |
|---|---|---|---|---|---|---|---|---|---|
| Peak elastic | MPa | <2000 | 1200 | 640 | 520 | 820 | 640 | 530 | 1800 |
| modulus | | | | | | | | | |
| Peak number | % | <25 | 13 | 10 | 9 | 11 | 1 | 8 | 22 |
| of counts | | | | | | | | | |

| After 7D | Presence or absence of voids | | A | A | A | A | A | A | A |
|---|---|---|---|---|---|---|---|---|---|
| bending | Presence or absence of course crystals | | A | A | A | A | A | A | A |
| | AC Breakdown electric field | kV/mm | 72 | 75 | 65 | 71 | 70 | 64 | 78 |

TABLE 2

| | | Peak molecular | | Storage | | | | | | | | | |
|---|---|---|---|---|---|---|---|---|---|---|---|---|---|
| | | weight in terms | | modulus (MPa) | | | | | | | | | |
| | | of styrene | Mw/Mn | at 25° C. | B1 | B2 | B3 | B4 | B5 | B6 | B7 | B8 | B9 |
| Resin A | PP1 | 230000 | 6.7 | 850 | | 80 | 40 | | 60 | 60 | 60 | 90 | 98 |
| | PP2 | 480000 | 6.2 | 1050 | 100 | | | | | | | | |
| | PP3 | 720000 | 5.1 | 1300 | | | | 60 | | | | | |
| Resin B | EPR1 | 200000 | 2.3 | 40 | | | | 40 | | | | | |
| | EPR2 | 700000 | 2.5 | 210 | | | | | 40 | | | | |
| | VLDPE1 | 120000 | 1.4 | 80 | | | 60 | | | | | | |
| | VLDPE2 | 270000 | 1.7 | 180 | | | | | | | | | |
| | SEBS1 | 30000 | 1.2 | 330 | | 20 | | | | | | | |
| | SEBS2 | 70000 | 1.1 | 70 | | | | | | | | | |
| | SEBS3 | 150000 | 1.1 | 5 | | | | | | | | | 2 |
| | Butyl | 600000 | 5.2 | 230 | | | | | | 40 | | | |
| | rubber 1 | | | | | | | | | | | | |
| | Butyl | 800000 | 5.2 | 350 | | | | | | | 40 | | |
| | rubber 2 | | | | | | | | | | | | |
| | Polybutene | 10000 | 2.1 | 0.1 | | | | | | | | 10 | |
| | (liquid) | | | | | | | | | | | | |

| Storage modulus of resin A/storage modulus of resin B | | | — | 3 | 11 | 33 | 4 | 4 | 2 | 850 | 170 |
|---|---|---|---|---|---|---|---|---|---|---|---|
| Immediately | Presence of absence of voids | | B | A | A | A | A | A | A | A | A |
| after | Presence or absence of coarse crystals | | A | A | A | A | A | A | A | A | A |
| production | Storage modulus of | MPa | 1050 | 730 | 370 | 760 | 580 | 590 | 620 | 490 | 620 |
| | molded body at 25° C. | | | | | | | | | | |
| | AC Breakdown | kV/mm | 25 | 73 | 53 | 61 | 63 | 68 | 70 | 63 | 74 |
| | electric field | | | | | | | | | | |

| | | | | | | | | | | |
|---|---|---|---|---|---|---|---|---|---|---|
| SPM | Number of normal distribution | 1 | 2 | 2 | 2 | 2 | 2 | 2 | 1 | 1 |

| | | | | | | | | | | | |
|---|---|---|---|---|---|---|---|---|---|---|---|
| Peak elastic | MPa | <2000 | 2300 | — | — | — | — | — | — | 580 | 2100 |
| modulus | | | | | | | | | | | |
| Peak number | % | <25 | 37 | — | — | — | — | — | — | 40 | 32 |
| of counts | | | | | | | | | | | |

| After 7D | Presence or absence of voids | | — | B | B | B | B | B | B | B | B |
|---|---|---|---|---|---|---|---|---|---|---|---|
| bending | Presence of absence of coarse crystals | | — | A | A | B | A | A | A | B | A |
| | AC Breakdown electric field | kV/mm | — | 21 | 18 | 12 | 20 | 18 | 17 | 13 | 25 |

### (Samples B1 and B9)

Each of the micro-region elasticity measurements of the sample B1 without the resin B mixed therein and the sample B9 with more than 95 parts by mass of the resin A content yielded a normal distribution with one peak, and the elastic modulus at the peak was high and the number of counts at the peak was also high. In the sample B1, many voids were already generated before the bending test. As a result, in the sample B1, the AC breakdown electric field was already low before the bending test. In the sample B9, fine voids were generated in the bending test. As a result, in the sample B9, AC breakdown electric field after the bending test was low. It is considered that, in the sample B1 and the sample B9, fine voids were generated during the bending due to excessive generation of the high-elastic regions derived from the resin A.

### (Sample B3)

In the sample B3 in which the content of the resin A was set to less than 52 parts by mass, the storage modulus of the molded body was lower than the storage modulus of the resin A itself. However, in the micro-region elasticity measurement of the sample B3, two peaks appeared. In the sample B3, many fine voids were generated in the bending test. As a result, in the sample B3, AC breakdown electric field after the bending test was low. It is considered that, in the sample B3, fine voids were generated during the bending due to excessive generation of the low-elastic regions derived from the resin B.

### (Sample B4)

In the sample B4 in which the peak molecular weight of the resin A was more than 6×10⁵ and the storage modulus of the resin A was more than 1200 MPa, a ratio of the storage modulus of the resin A to the storage modulus of the resin B was within a predetermined range due to the use of the rein B having low elastic modulus. Further, the elastic modulus of the molded body was lower than the storage modulus of the resin A itself. However, in the micro-region elasticity measurement of the sample B4, two peaks appeared. In the sample B4, many fine voids and coarse crystals were generated in the bending test. As a result, in the sample B4, the AC breakdown electric field after the bending test was low. It is considered that, in the sample B4, fine voids and coarse crystals were generated during the bending due to formation of the high-elastic regions derived from the resin A in which the elastic modulus was excessively high.

### (Samples B5 to B7)

In the samples B5 to B7 in which the peak molecular weight of the resin B was more than 4×10⁵ and the storage modulus of the resin B was more than 200 MPa, a ratio of the storage modulus of the resin B to the storage modulus of the resin A was less than 5. The sample B6 and the sample B7 did not satisfy the requirements for Mw/Mn. Therefore, in the micro-region elasticity measurement of the samples B5 to B7, two peaks appeared. In the samples B5 to B7, many fine voids were generated in the bending test. As a result, in the samples B5 to B7, the AC breakdown electric field after the bending test was low. In the samples B5 to B7, it is considered that since the resin A and the resin B were not sufficiently mixed due to the resin B which did not satisfy the above-described requirements, fine voids were generated during the bending.

### (Samples B2 and B8)

In the sample B2 in which the peak molecular weight of the resin B made of SEBS was less than 4×10⁴ and the storage modulus of the resin B was more than 200 MPa, a ratio of the storage modulus of the resin A to the storage modulus of the resin B was less than 5. Therefore, in the micro-region elasticity measurement of the sample B2, two peaks appeared. In the sample B2, many fine voids were generated in the bending test. As a result, in the sample B2, AC breakdown electric field after the bending test was low. In the sample B2, it is considered that since the resin A and the resin B were not sufficiently mixed due to the resin B which did not satisfy the above-described requirements, fine voids were generated during the bending.

On the other hand, in the sample B8 in which the peak molecular weight of the resin B made of polybutene as a liquid oil was less than 4×10⁴ and the storage modulus of the resin B was less than 1 MPa, a ratio of the storage modulus of the resin A to the storage modulus of the resin B was more than 200. The micro-region elasticity measurement of the sample B8 yielded a normal distribution with one peak, but the number of counts at the peak was high. In the sample B8, many fine voids and coarse crystals were generated in the bending test. As a result, in the sample B8, AC breakdown electric field after the bending test was low. In the sample B8, due to the excessively low storage modulus of the resin B, the resin A and the resin B were not sufficiently mixed, so that only the resin A which is a PP-based resin was aggregated and crystallized. Therefore, it is considered that fine voids and coarse crystals were generated during the bending.

### (Samples A1 to A7)

In the micro-region elasticity measurement of the samples A1 to A7 which satisfy the requirements for molecular weight distribution, storage modulus, and compounding ratio, as for the first requirement, a normal distribution with only one peak appeared in a region in which the number of counts is 4000 or more. Further, as for the second requirement, the elastic modulus at the peak of the normal distribution was 2000 MPa or less. As for the third requirement, the number of counts at the peak of the normal distribution was less than 25% of the total number of tapping. In the samples A1 to A7, fine voids and coarse crystals were not present in the bending test. As a result, in the samples A1 to A7, the AC breakdown electric field after the bending test was 60 kV/mm or more.

For the samples A1 to A7, the content of the resin A was set to 52 parts by mass or more and 95 parts by mass or less with respect to a total content of the resin A and the resin B being 100 parts by mass. By setting the content of the resin A to 52 parts by mass or more, excessive generation of the low-elastic region can be suppressed. Accordingly, it is confirmed that generation of fine voids can be reduced during the bending. On the other hand, by setting the content of the resin A to 95 parts by mass or less, excessive generation of the high-elastic region can be suppressed. Accordingly, it is confirmed that generation of fine voids can be reduced during the bending.

For the samples A1 to A7, the peak molecular weight in the molecular weight distribution of the resin A is set to 6×10⁴ or more and 6×10⁵ or less, and Mw/Mn of the resin A is set to 3.0 or more and 8.0 or less. Further, the peak molecular weight in the molecular weight distribution of the resin B is set to 4×10⁴ or more and 4×10⁵ or less, and Mw/Mn of the resin B is set to 1.1 or more and 3.0 or less. Thus, the insulating layer can be stably molded, the resin A and the resin B can be homogeneously mixed, and localization of each of the resin A and the resin B can be suppressed. As a result, it is confirmed that generation of fine voids and coarse crystals during the bending can be suppressed.

For the samples A1 to A7, the storage modulus of the resin A at 25° C. is set to 600 MPa or more and 1200 MPa or less, and the storage modulus of the resin B at 25° C. is set to 1 MPa or more and 200 MPa or less. Alternatively, a ratio of the storage modulus of the resin A to the storage modulus of the resin B at 25° C. is set to 5 or more and 200 or less. This makes it possible to obtain an effect equivalent to the effect of the resin A and the resin B satisfying the requirements for molecular weight distribution described above. That is, the resin A and the resin B can be homogeneously mixed, and localization of each of the resin A and the resin B can be suppressed. As a result, it is confirmed that generation of fine voids and coarse crystals during the bending can be suppressed.

As described above, the results of the samples A1 to A7 confirm that degradation of the insulation after the bending can be reduced.

### PREFERRED ASPECT OF DISCLOSURE

Hereinafter, supplementary descriptions of the preferred aspects of the present disclosure will be given.

### Supplementary Description 1

A resin composition to be coated on a circumference of an elongated object, including propylene units,
wherein there are no voids with a maximum length of 1 μm or more nor crystals with a maximum length of more than 10 μm in a molded body including the resin composition after a predetermined bending test,
where the bending test includes a first step of bending the molded body so that a bending ratio of a bending radius of the molded body to an outer diameter of the molded body is 7 or less, and a second step of bending the molded body in a direction opposite to a bending direction in the first step at the same bending ratio as the bending ratio in the first step.

### Supplementary Description 2

A resin composition molded body coated on a circumference of an elongated object, including propylene units,
wherein there are no voids with a maximum length of 1 μm or more nor crystals with a maximum length of more than 10 μm in the resin composition molded body after a predetermined bending test,
where the bending test includes a first step of bending the resin composition molded body so that a bending ratio of a bending radius of the resin composition molded body to an outer diameter of the resin composition molded body is 7 or less, and a second step of bending the resin composition molded body in a direction opposite to a bending direction in the first step at the same bending ratio as the bending ratio in the first step.

### Supplementary Description 3

The resin composition molded body according to supplementary description 2,
wherein the resin composition molded body satisfies a first requirement, a second requirement, and a third requirement in a distribution of number of counts with respect to an elastic modulus of the resin composition molded body, determined by a micro-region elasticity measurement using a scanning probe microscope,
where the elastic modulus is measured under conditions of tapping within a 10 μm square area of the resin composition molded body 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

### Supplementary Description 4

A resin composition molded body, including propylene units,
wherein the resin composition molded body satisfies a first requirement, a second requirement, and a third requirement in a distribution of number of counts with respect to an elastic modulus of the resin composition molded body, determined by a micro-region elasticity measurement using a scanning probe microscope,
where the elastic modulus is measured under conditions of tapping within a 10 μm square area of the resin composition molded body 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

### Supplementary Description 5

The resin composition molded body according to any one of supplementary descriptions 2 to 4,
wherein the resin composition molded body includes
   a resin A that contains propylene units, and
   a resin B that contains 2 or more types of monomer units and is solid at 25° C.

### Supplementary Description 6

The resin composition molded body according to supplementary description 5,
wherein a content of the resin A is 52 parts by mass or more and 95 parts by mass or less with respect to a total content of the resin A and the resin B being 100 parts by mass.

### Supplementary Description 7

The resin composition molded body according to supplementary description 5 or 6,
wherein a storage modulus of the resin A at 25° C. measured by a dynamic mechanical analysis is 600 MPa or more and 1200 MPa or less, and
a storage modulus of the resin B at 25° C. measured by a dynamic mechanical analysis is 1 MPa or more and 200 MPa or less.

### Supplementary Description 8

A resin composition molded body, including:
a resin A that contains propylene units, and
a resin B that contains 2 or more types of monomer units and is solid at 25° C.,
wherein a storage modulus of the resin A at 25° C. measured by a dynamic mechanical analysis is 600 MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

### Supplementary Description 9

The resin composition molded body according to any one of supplementary descriptions 5 to 8,
wherein a ratio of a storage modulus of the resin A to a storage modulus of the resin B, at 25° C. measured by a dynamic mechanical analysis, is 5 or more and 200 or less.

### Supplementary Description 10

A resin composition molded body, including:
a resin A that contains propylene units, and
a resin B that contains 2 or more types of monomer units and is solid at 25° C.,
wherein a ratio of a storage modulus of the resin A to a storage modulus of the resin B, at 25° C. measured by a dynamic mechanical analysis, is 5 or more and 200 or less, and
a content of the resin A is 52 parts by mass or more and 95 parts by mass or less with respect to a total content of the resin A and the resin B being 100 parts by mass.

### Supplementary Description 11

The resin composition molded body according to any one of supplementary descriptions 5 to 10,
wherein a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

### Supplementary Description 12

A resin composition molded body, including:
a resin A that contains propylene units, and
a resin B that contains 2 or more types of monomer units,
wherein a peak molecular weight in a molecular weight distribution of the resin A is 6×10⁴ or more and 6×10⁵ or less,
Mw/Mn of the resin A is 3.0 or more and 8.0 or less, and
a peak molecular weight in a molecular weight distribution of the resin B is 4×10⁴ or more and 4×10⁵ or less,
Mw/Mn of the resin B is 1.1 or more and 3.0 or less, and
a content of the resin A is 52 parts by mass or more and 95 parts by mass or less with respect to a total content of the resin A and the resin B being 100 parts by mass,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

### Supplementary Description 13

The resin composition molded body according to any one of supplementary descriptions 5 to 12,
wherein the resin B includes a copolymer obtained by copolymerization of at least any two of ethylene, propylene, butene, hexene, octene, isoprene, and styrene.

### Supplementary Description 14

The resin composition molded body according to any one of supplementary descriptions 1 to 13,
wherein an AC breakdown electric field at an ordinary temperature is 60 kV/mm or more.

### Supplementary Description 15

A power cable including:
a conductor, and
an insulating layer coated on a circumference of the conductor,
wherein the insulating layer includes propylene units,
there are no voids with a maximum length of 1 μm or more nor crystals with a maximum length of more than 10 μm in the insulating layer after a predetermined bending test,
where the bending test includes a first step of bending the power cable so that a bending ratio of a bending radius of the power cable to an outer diameter of the insulating layer is 7 or less, and a second step of bending the power cable in a direction opposite to a bending direction in the first step at the same bending ratio as the bending ratio in the first step.

### Supplementary Description 16

A power cable including:
a conductor, and
an insulating layer coated on a circumference of the conductor,
wherein the insulating layer includes propylene units,
the insulating layer satisfies a first requirement, a second requirement, and a third requirement in a distribution of number of counts with respect to an elastic modulus of the insulating layer, determined by a micro-region elasticity measurement using a scanning probe microscope,
where the elastic modulus is measured under conditions of tapping within a 10 μm square area of the insulating layer 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000

MPa or less, and
the third requirement is that the number of counts at the peak of the normal distribution is less than 25% of the total number of tapping.

### Supplementary Description 17

A power cable including:
a conductor, and
an insulating layer coated on a circumference of the conductor,
wherein the insulating layer includes
   a resin A that contains propylene units, and
   a resin B that contains 2 or more types of monomer units and is solid at 25° C.,
a storage modulus of the resin A at 25° C. measured by a dynamic mechanical analysis is 600

MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

### Supplementary Description 18

A power cable including:
a conductor, and
an insulating layer coated on a circumference of the conductor,
wherein the insulating layer includes
   a resin A that contains propylene units, and
   a resin B that contains 2 or more types of monomer units and is solid at 25° C.,
a ratio of a storage modulus of the resin A to a storage modulus of the resin B, at 25° C. measured by a dynamic mechanical analysis, is 5 or more and 200 or less,
a content of the resin A is 52 parts by mass or more and 95 parts by mass or less with respect to the total content of the resin A and the resin B being 100 parts by mass.

### Supplementary Description 19

A power cable including:
a conductor, and
an insulating layer coated on a circumference of the conductor,
wherein the insulating layer includes
   a resin A that contains propylene units, and
   a resin B that contains 2 or more types of monomer units,
a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less, and
a content of the resin A is 52 parts by mass or more and 95 parts by mass or less with respect to a total content of the resin A and the resin B being 100 parts by mass,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

### Supplementary Description 20

A method of producing a power cable, including:
preparing a resin composition including a resin A that contains propylene units and a resin B that contains 2 or more types of monomer units and is solid at 25° C.; and
coating an insulating layer on a circumference of a conductor using the resin composition,
wherein, in the preparation of the resin composition,
a storage modulus of the resin A at 25° C. measured by a dynamic mechanical analysis is set to 600 MPa or more and 1200 MPa or less,
a storage modulus of the resin B at 25° C. measured by a dynamic mechanical analysis is set to 1 MPa or more and 200 MPa or less, and
a content of the resin A is set to 52 parts by mass or more and 95 parts by mass or less with respect to a total content of the resin A and the resin B being 100 parts by mass.

### Supplementary Description 21

A method of producing a power cable, including:
preparing a resin composition including a resin A that contains propylene units and a resin B that contains 2 or more types of monomer units and is solid at 25° C.,
coating an insulating layer on a circumference of a conductor using the resin composition,
wherein, in the preparation of the resin composition,
a ratio of a storage modulus of the resin A to a storage modulus of the resin B, at 25° C. measured by a dynamic mechanical analysis, is set to 5 or more and 200 or less, and
a content of the resin A is set to 52 parts by mass or more and 95 parts by mass or less with respect to a total content of the resin A and the resin B being 100 parts by mass.

### Supplementary Description 22

A method of producing a power cable, including:
preparing a resin composition including a resin A that contains propylene units and a resin B that contains 2 or more types of monomer units, and
coating an insulating layer on a circumference of a conductor using the resin composition,
wherein, in the preparation of the resin composition,
a peak molecular weight in a molecular weight distribution of the resin A is set to 6×10⁴ or more and 6×10⁵ or less,
Mw/Mn of the resin A is set to 3.0 or more and 8.0 or less,
a peak molecular weight in a molecular weight distribution of the resin B is set to 4×10⁴ or more and 4×10⁵ or less,
Mw/Mn of the resin B is set to 1.1 or more and 3.0 or less, and
a content of the resin A is set to 52 parts by mass or more and 95 parts by mass or less with respect to a total content of the resin A and the resin B being 100 parts by mass,
where the molecular weight distribution of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

### REFERENCE SIGNS LIST

10 Power cable
110 Conductor
120 Internal semiconductive layer
130 Insulating layer
140 External semiconductive layer
150 Shielding layer
160 Sheath

1-3. (canceled)

4. A resin composition molded body, including propylene units,
wherein the resin composition molded body satisfies a first requirement, a second requirement, and a third requirement in a distribution of number of counts with respect to an elastic modulus of the resin composition molded body, determined by a micro-region elasticity measurement using a scanning probe microscope,
where the elastic modulus is measured under conditions of tapping within a 10 μm square area of the resin composition molded body 60000 times at 25° C. with a cantilever having a tip that is made of silicon and has a radius of curvature of less than 20 nm in the micro-region elasticity measurement,
the first requirement is that a normal distribution with only one peak appears in a region in which the number of counts is 4000 or more,
the second requirement is that the elastic modulus at the peak of the normal distribution is 2000 MPa or less, and
the third requirement is that the number of counts at the peak of the normal distribution is less than 25% of the total number of tapping.

5. The resin composition molded body according to claim 4,
wherein the resin composition molded body comprises
a resin A that contains propylene units, and
a resin B that contains 2 or more types of monomer units and is solid at 25° C.

6. The resin composition molded body according to claim 5,
wherein a content of the resin A is 52 parts by mass or more and 95 parts by mass or less with respect to a total content of the resin A and the resin B being 100 parts by mass.

7. The resin composition molded body according to claim 5,
wherein a storage modulus of the resin A at 25° C. measured by a dynamic mechanical analysis is 600 MPa or more and 1200 MPa or less, and
a storage modulus of the resin B at 25° C. measured by a dynamic mechanical analysis is 1 MPa or more and 200 MPa or less.

8. A resin composition molded body, comprising:
a resin A that contains propylene units; and
a resin B that contains 2 or more types of monomer units and is solid at 25° C.,
wherein a storage modulus of the resin A at 25° C. measured by a dynamic mechanical analysis is 600 MPa or more and 1200 MPa or less,
a storage modulus of the resin B at 25° C. measured by a dynamic mechanical analysis is 1 MPa or more and 200 MPa or less, and
a content of the resin A is 52 parts by mass or more and 95 parts by mass or less with respect to a total content of the resin A and the resin B being 100 parts by mass.

9. The resin composition molded body according to claim 5,
wherein a ratio of a storage modulus of the resin A to a storage modulus of the resin B, at 25° C. measured by a dynamic mechanical analysis, is 5 or more and 200 or less.

10. A resin composition molded body, comprising:
a resin A that contains propylene units; and
a resin B that contains 2 or more types of monomer units and is solid at 25° C.,
wherein a ratio of a storage modulus of the resin A to a storage modulus of the resin B, at 25° C. measured by a dynamic mechanical analysis, is 5 or more and 200 or less, and
a content of the resin A is 52 parts by mass or more and 95 parts by mass or less with respect to a total content of the resin A and the resin B being 100 parts by mass.

11. The resin composition molded body according to claim 5,
wherein a peak molecular weight in a molecular weight distribution of the resin A is 6×10⁴ or more and 6×10⁵ or less,
Mw/Mn of the resin A is 3.0 or more and 8.0 or less,
a peak molecular weight in a molecular weight distribution of the resin B is 4×10⁴ or more and 4×10⁵ or less,
Mw/Mn of the resin B is 1.1 or more and 3.0 or less,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

12. A resin composition molded body, comprising:
a resin A that contains propylene units; and
a resin B that contains 2 or more types of monomer units,
wherein a peak molecular weight in a molecular weight distribution of the resin A is 6×10⁴ or more and 6×10⁵ or less,
Mw/Mn of the resin A is 3.0 or more and 8.0 or less, and
a peak molecular weight in a molecular weight distribution of the resin B is 4×10⁴ or more and 4×10⁵ or less,
Mw/Mn of the resin B is 1.1 or more and 3.0 or less, and
a content of the resin A is 52 parts by mass or more and 95 parts by mass or less with respect to a total content of the resin A and the resin B being 100 parts by mass,
where the molecular weight distribution of each of the resin A or the resin B is measured by gel permeation chromatography based on a calibration curve prepared using polystyrene as a standard sample,
Mw is a weight average molecular weight in the molecular weight distribution, and
Mn is a number average molecular weight in the molecular weight distribution.

13. (canceled)

14. A power cable comprising:
a conductor; and
an insulating layer coated on a circumference of the conductor,
wherein the insulating layer is formed of the resin composition molded body according to claim 4.

15. A power cable comprising:
a conductor; and
an insulating layer coated on a circumference of the conductor,
wherein the insulating layer is formed of the resin composition molded body according to claim 8.

16. A power cable comprising:
a conductor; and
an insulating layer coated on a circumference of the conductor,
wherein the insulating layer is formed of the resin composition molded body according to claim 10.

17. A power cable comprising:
a conductor; and
an insulating layer coated on a circumference of the conductor,
wherein the insulating layer is formed of the resin composition molded body according to claim 12.

18. A method of producing a power cable according to claim 15, the method including the steps of:
preparing a resin composition including the resin A that contains propylene units and the resin B that contains 2 or more types of monomer units and is solid at 25° C.; and
coating the insulating layer on the circumference of the conductor using the resin composition.

19. A method of producing a power cable according to claim 16, the method including the steps of:
preparing a resin composition including the resin A that contains propylene units and the resin B that contains 2 or more types of monomer units and is solid at 25° C.; and
coating the insulating layer on the circumference of the conductor using the resin composition.

20. A method of producing a power cable according to claim 17, the method including the steps of:
preparing a resin composition including the resin A that contains propylene units and the resin B that contains 2 or more types of monomer units; and
coating the insulating layer on the circumference of the conductor using the resin composition.

21. The resin composition molded body according to claim 4,
wherein there are no voids with a maximum length of 1 μm or more nor crystals with a maximum length of more than 10 μm in the resin composition molded body after a predetermined bending test,
where the bending test includes a first step of bending the resin composition molded body so that a bending ratio of a bending radius of the resin composition molded body to an outer diameter of the resin composition molded body is 7 or less, and
a second step of bending the resin composition molded body in a direction opposite to a bending direction in the first step at the same bending ratio as the bending ratio in the first step.

22. A power cable comprising:
a conductor; and
an insulating layer coated on a circumference of the conductor,
wherein the insulating layer is formed of the resin composition molded body according to claim 21.
